(19) United States
(12) Patent Application Publication
(10) Pub. No.: US 2019/0352463 A1
(43) Pub. Date: Nov. 21, 2019

(54) POLYIMIDE PRECURSOR RESIN COMPOSITION

(71) Applicant: ASAHI KASEI KABUSHIKI KAISHA, Tokyo (JP)

(72) Inventors: Masaki MAITANI, Tokyo (JP); Toshiaki OKUDA, Tokyo (JP); Takayuki KANADA, Tokyo (JP)

(73) Assignee: ASAHI KASEI KABUSHIKI KAISHA, Tokyo (JP)

(21) Appl. No.: 16/407,647

(22) Filed: May 9, 2019

(30) Foreign Application Priority Data
May 16, 2018 (JP) 2018-094313
Apr. 19, 2019 (JP) 2019-080465

(51) Int. Cl. C08G 73/10; C08L 79/08; C08J 5/18

(52) U.S. Cl. CPC C08G 73/106; C08G 73/1007; C08L 79/08; C08J 2379/08; C08L 2203/16; C08L 2203/20; C08J 5/18

(57) ABSTRACT

A solvent for a resin composition that includes a polyimide precursor having a structure unit derived from polyamic acid and a structure unit derived from siloxane having a monovalent aliphatic hydrocarbon group of 1 to 5 carbon atoms or a monovalent aromatic group of 6 to 10 carbon atoms. The solvent is a mixture of an amide-based solvent and a non-amide-based solvent having a boiling point of 160° C. or higher, and the resin composition includes cyclic siloxane.

### BACKGROUND OF THE INVENTION

### 1. Field of the Invention

The present invention relates to a polyimide precursor resin composition and a polyimide film, and methods for manufacturing the polyimide film, a display, a laminate and a flexible device.

### 2. Description of the Related Art

A polyimide resin is an insoluble or infusible super heat-resistant resin and has excellent properties such as thermal oxidation resistance, heat resistance, radiation resistance, low temperature resistance, chemical resistance, etc. For this reason, polyimide resins are used in a wide range of fields including electronic materials. Examples of application of the polyimide resin in the field of electronic materials include dielectric coating materials, dielectric films, semiconductors, electrode protective films for a thin film transistor liquid crystal display (TFT-LCD), etc. In recent years, the application thereof as a flexible substrate utilizing lightness or flexibility thereof has also been considered in place of glass substrates conventionally used in a field of display materials.

For the purpose of modifying the polyimide resin, a polyimide silicone obtained by incorporating a siloxane chain into a polyimide backbone and a resin composition thereof have been studied (PTLs 1 and 2). In PTL 1, there is proposed a polyimide silicone in which low molecular weight cyclic siloxane is reduced by purification procedure since when the amount of the low molecular weight cyclic siloxane (cyclic siloxane having a relatively low molecular weight) in the polyimide precursor resin composition is large, the polyimide film becomes opaque when formed into a film. PTL 2 describes that adhesiveness of the obtained polyimide silicone is improved when using a siloxane-containing compound purified by stripping the siloxane-containing compound under specific conditions or dissolving the siloxane-containing compound in 2-butanone followed by reprecipitation with methanol.

Moreover, investigations have been carried out regarding solvents of polyimide precursor resin compositions (PTLs 1, 3, and 4). PTL 1 describes that when a mixture of a solvent having a boiling point of 160° C. or higher and a solvent having a boiling point of less than 160° C. is used, clouding of the polyimide film is reduced. Although the polyimide precursor resin composition containing the mixture of two or more types of solvents is also described in PTLs 3 and 4, these two literatures do not focus on the low molecular weight cyclic siloxane in the polyimide precursor resin composition, or the purification thereof.

### CITATION LIST

### Patent Literature

[PTL 1] Japanese Unexamined Patent Publication No. 2016-029126
[PTL 2] Japanese Unexamined Patent Publication No. 2006-028533
[PTL 3] WO2012/118020
[PTL 4] WO2013/047451

### SUMMARY OF THE INVENTION

In recent years, for the purpose of ensuring the visibility of a device, it has been required to improve transparency of a polyimide film or a substrate disposed in a device while suppressing retardation and YI value to the same level as those in the prior art. With regard thereto, PTL 1 describes a polyimide precursor using a solvent having a boiling point of 160° C. or higher and a solvent having a boiling point of 160° C. or lower, which enables to improve the transparency of the obtained polyimide film without clouding since the precursor contains the solvent having a low boiling point, which accelerates the drying rate of the solvent. However, as confirmed by the present inventors, it has been found that the haze can be further improved by changing the solvent in the resin composition described in PTL 1, and in the case of the embodiment described in PTL 1, there is a problem that a foreign substance, as will be described later, has a likelihood of being generated in the coating film. Moreover, the polyimide silicone described in PTL 2 is the one that improves adhesiveness.

Accordingly, an object of the present invention is to provide a polyimide film and a polyimide precursor resin composition that improve transparency to reduce haze, and reduce a foreign substance attached to a coating film.

The aforementioned problem is solved by the following technological means.

[1] A resin composition comprising:

a polyimide precursor containing:
a structure unit represented by formula (1):

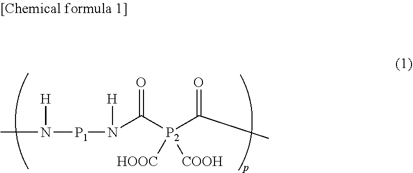

wherein P₁ represents a divalent organic group, P₂ represents a tetravalent organic group, and p is a positive integer, and
a structure unit represented by formula (2):

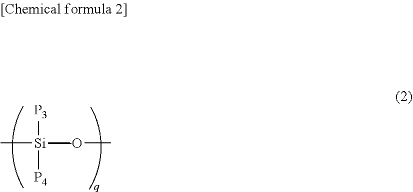

wherein P₃ and P₄ are each independently a monovalent aliphatic hydrocarbon group of 1 to 5 carbon atoms or a monovalent aromatic group of 6 to 10 carbon atoms, and q is a positive integer; and

a solvent;

wherein the solvent is a mixture of an amide-based solvent and a non-amide-based solvent having a boiling point of 160° C. or higher, and

the resin composition comprises a compound represented by formula (3):

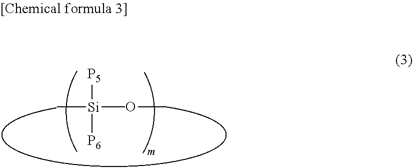

wherein P₅ and P₆ are each independently a monovalent aliphatic hydrocarbon group of 1 to 5 carbon atoms or an aromatic group of 6 to 10 carbon atoms, and m is a positive integer, in an amount of greater than 0 ppm to 1200 ppm or less based on a weight of the resin composition.
[2] The resin composition according to [1], wherein P₅ and P₆ are each independently an aromatic group of 6 to 10 carbon atoms, and m is a positive integer in formula (3).
[3] The resin composition according to [1] or [2], wherein m is 3 or greater in formula (3).
[4] A resin composition comprising:

a polyimide precursor containing:
a structure unit represented by formula (1):

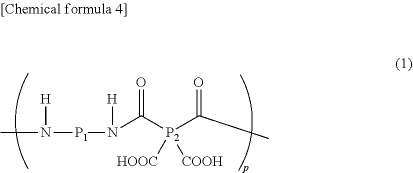

wherein P₁ represents a divalent organic group, P₂ represents a tetravalent organic group, and p is a positive integer, and
a structure unit represented by formula (2):

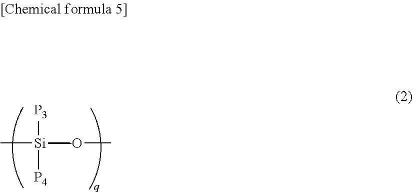

wherein P₃ and P₄ are each independently a monovalent aliphatic hydrocarbon group of 1 to 5 carbon atoms or a monovalent aromatic group of 6 to 10 carbon atoms, and q is a positive integer; and

a solvent;

wherein the solvent is a mixture of an amide-based solvent and a non-amide-based solvent having a boiling point of 160° C. or higher, and

the resin composition comprises a compound represented by formula (3):

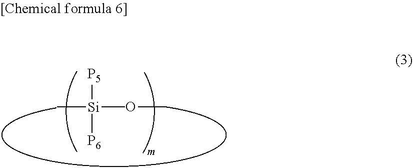

wherein P₅ and P₆ are each independently an aromatic group of 6 to 10 carbon atoms and m is 3, in an amount of greater than 0 ppm to 700 ppm or less based on a weight of the resin composition.
[5] A resin composition comprising:

a polyimide precursor containing:
a structure unit represented by formula (1):

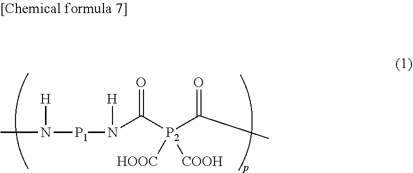

wherein P₁ represents a divalent organic group, P₂ represents a tetravalent organic group, and p is a positive integer, and
a structure unit represented by formula (2):

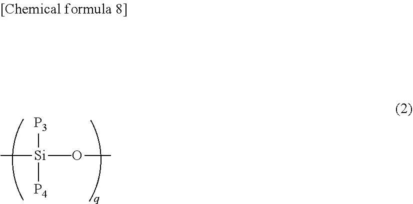

wherein P₃ and P₄ are each independently a monovalent aliphatic hydrocarbon group of 1 to 5 carbon atoms or a monovalent aromatic group of 6 to 10 carbon atoms, and q is a positive integer; and

a solvent;

wherein the solvent is a mixture of an amide-based solvent and a non-amide-based solvent having a boiling point of 160° C. or higher, and

the resin composition comprises a compound represented by formula (3):

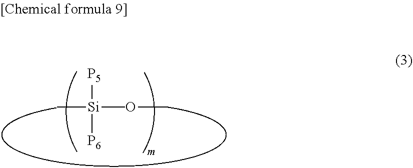

wherein P₅ and P₆ are each independently a monovalent aliphatic hydrocarbon group of 1 to 5 carbon atoms and m is 5, in an amount of greater than 0 ppm to 35 ppm or less based on a weight of the resin composition.
[6] A resin composition comprising:

a polyimide precursor containing:
a structure unit represented by formula (1):

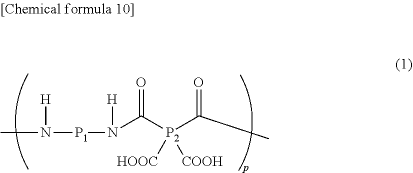

wherein P₁ represents a divalent organic group, P₂ represents a tetravalent organic group, and p is a positive integer, and
a structure unit represented by formula (2):

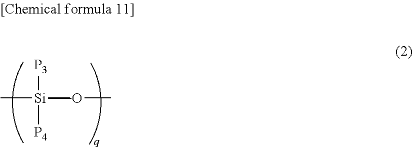

wherein P₃ and P₄ are each independently a monovalent aliphatic hydrocarbon group of 1 to 5 carbon atoms or a monovalent aromatic group of 6 to 10 carbon atoms, and q is a positive integer; and

a solvent;

wherein the solvent is a mixture of an amide-based solvent and a non-amide-based solvent having a boiling point of 160° C. or higher, and

the resin composition comprises a compound represented by formula (3):

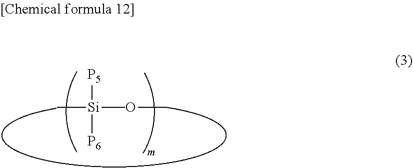

wherein P₅ and P₆ are each independently an aromatic group of 6 to 10 carbon atoms and m is 3, in an amount of greater than 0 ppm to 5000 ppm or less based on a solid content weight of the resin composition.
[7] A resin composition comprising:

a polyimide precursor containing:
a structure unit represented by formula (1):
   [Chemical formula 13]

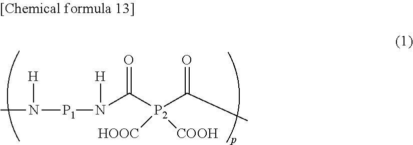

wherein P₁ represents a divalent organic group, P₂ represents a tetravalent organic group, and p is a positive integer, and
a structure unit represented by formula (2):

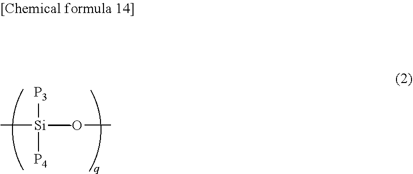

wherein P₃ and P₄ are each independently a monovalent aliphatic hydrocarbon group of 1 to 5 carbon atoms or a monovalent aromatic group of 6 to 10 carbon atoms, and q is a positive integer; and

a solvent;

wherein the solvent is a mixture of an amide-based solvent and a non-amide-based solvent having a boiling point of 160° C. or higher, and

the resin composition comprises a compound represented by formula (3):

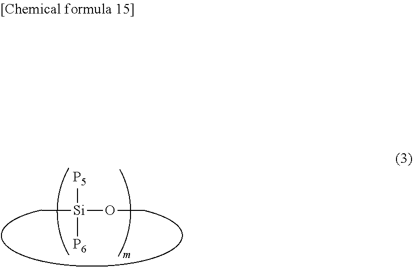

wherein P₅ and P₆ are each independently a monovalent aliphatic hydrocarbon group of 1 to 5 carbon atoms and m is 5, in an amount of greater than 0 ppm to 300 ppm or less based on a solid content weight of the resin composition.
[8] A resin composition comprising:

a polyimide precursor which is a copolymer containing as monomer units:
a silicon-containing compound represented by formula (4):

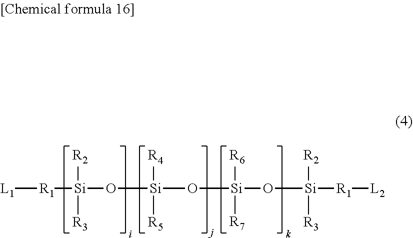

wherein R₁ is each independently single bond or a divalent organic group of 1 to 10 carbon atoms, R₂ and R₃ are each independently a monovalent aliphatic hydrocarbon group of 1 to 5 carbon atoms, R₄ and R₅ are each independently a monovalent aromatic group of 6 to 10 carbon atoms, R₆ and R₇ are each independently a monovalent organic group of 1 to 10 carbon atoms, at least one of R₆ and R₇ is an organic group having an unsaturated aliphatic hydrocarbon group, L₁ and L₂ are each independently an amino group, an acid anhydride group, an isocyanate group, a carboxy group, an acid ester group, an acid halide group, a hydroxy group, an epoxy group or a mercapto group, i is an integer of 1 to 200, and j and k are each independently an integer of 0 to 200,
tetracarboxylic acid dianhydride, and
diamine; and

a compound represented by formula (3):

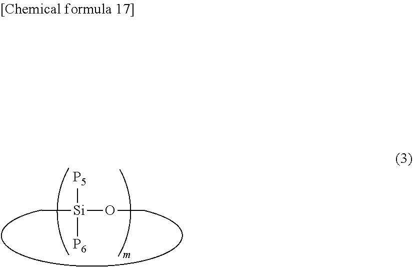

wherein P₅ and P₆ are each independently a monovalent aliphatic hydrocarbon group of 1 to 5 carbon atoms or an aromatic group of 6 to 10 carbon atoms, and m is a positive integer,

wherein a total amount of the compound represented by formula (3) provided that P₅ and P₆ are each independently an aromatic group of 6 to 10 carbon atoms and m is 3, is greater than 0 ppm to 25000 ppm or less based on weights of the compound represented by formula (3) and the silicon-containing compound represented by formula (4).

[9] A resin composition comprising:

a polyimide precursor which is a copolymer containing as monomer units:
a silicon-containing compound represented by formula (4):

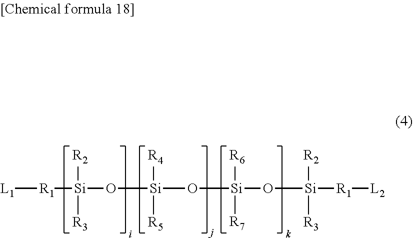

wherein R₁ is each independently single bond or a divalent organic group of 1 to 10 carbon atoms, R₂ and R₃ are each independently a monovalent aliphatic hydrocarbon group of 1 to 5 carbon atoms, R₄ and R₅ are each independently a monovalent aromatic group of 6 to 10 carbon atoms, R₆ and R₇ are each independently a monovalent organic group of 1 to 10 carbon atoms, at least one of R₆ and R₇ is an organic group having an unsaturated aliphatic hydrocarbon group, L₁ and L₂ are each independently an amino group, an acid anhydride group, an isocyanate group, a carboxy group, an acid ester group, an acid halide group, a hydroxy group, an epoxy group or a mercapto group, i is an integer of 1 to 200, and j and k are each independently an integer of 0 to 200,
tetracarboxylic acid dianhydride, and
diamine; and

a compound represented by formula (3):

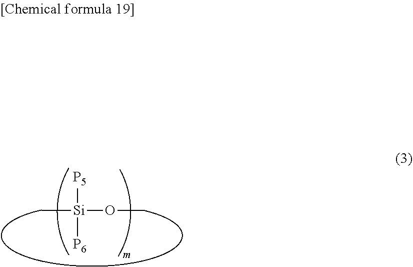

wherein P₅ and P₆ are each independently a monovalent aliphatic hydrocarbon group of 1 to 5 carbon atoms or an aromatic group of 6 to 10 carbon atoms, and m is a positive integer,

wherein a total amount of the compound represented by formula (3) provided that P₅ and P₆ are each independently a monovalent aliphatic hydrocarbon group of 1 to 5 carbon atoms and m is 5, is greater than 0 ppm to 1500 ppm or less based on weights of the compound represented by formula (3) and the silicon-containing compound represented by formula (4).

[10] A method of preparing a resin composition, comprising:

providing a polyimide precursor by subjecting a silicon-containing compound containing:
a compound represented by formula (4):

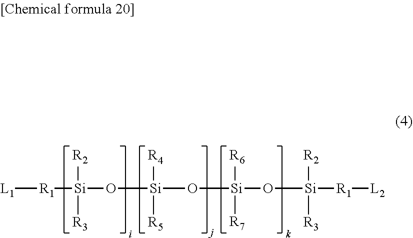

wherein R₁ is each independently single bond or a divalent organic group of 1 to 10 carbon atoms, R₂ and R₃ are each independently a monovalent aliphatic hydrocarbon group of 1 to 5 carbon atoms, R₄ and R₅ are each independently a monovalent aromatic group of 6 to 10 carbon atoms, R₆ and R₇ are each independently a monovalent organic group of 1 to 10 carbon atoms, at least one of R₆ and R₇ is an organic group having an unsaturated aliphatic hydrocarbon group, L₁ and L₂ are each independently an amino group, an acid anhydride group, an isocyanate group, a carboxy group, an acid ester group, an acid halide group, a hydroxy group, an epoxy group or a mercapto group, i is an integer of 1 to 200, and j and k are each independently an integer of 0 to 200, and a compound represented by formula (3):

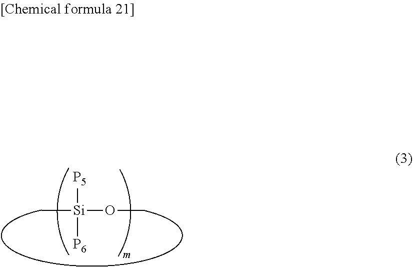

wherein P₅ and P₆ are each independently a monovalent aliphatic hydrocarbon group of 1 to 5 carbon atoms or an aromatic group of 6 to 10 carbon atoms, and m is a positive integer;

tetracarboxylic acid dianhydride; and

diamine;

to polymerization reaction,

wherein a total amount of the compound represented by formula (3) provided that P₅ and P₆ are each independently an aromatic group of 6 to 10 carbon atoms and m is 3, is greater than 0 ppm to 25000 ppm or less based on weights of the compound represented by formula (3) and the silicon-containing compound represented by formula (4).

[11] A method of preparing a resin composition, comprising:

providing a polyimide precursor by subjecting a silicon-containing compound containing:
a compound represented by formula (4):

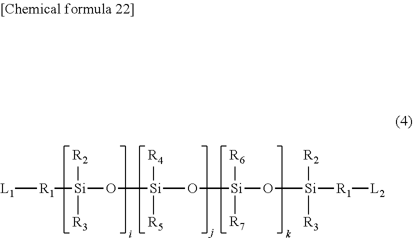

wherein R₁ is each independently single bond or a divalent organic group of 1 to 10 carbon atoms, R₂ and R₃ are each independently a monovalent aliphatic hydrocarbon group of 1 to 5 carbon atoms, R₄ and R₅ are each independently a monovalent aromatic group of 6 to 10 carbon atoms, R₆ and R₇ are each independently a monovalent organic group of 1 to 10 carbon atoms, at least one of R₆ and R₇ is an organic group having an unsaturated aliphatic hydrocarbon group, L₁ and L₂ are each independently an amino group, an acid anhydride group, an isocyanate group, a carboxy group, an acid ester group, an acid halide group, a hydroxy group, an epoxy group or a mercapto group, i is an integer of 1 to 200, and j and k are each independently an integer of 0 to 200, and a compound represented by formula (3):

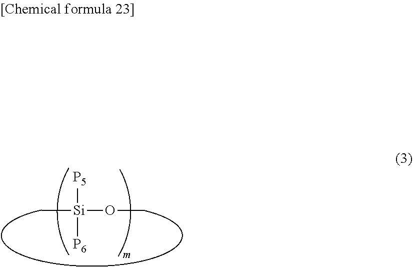

wherein P₅ and P₆ are each independently a monovalent aliphatic hydrocarbon group of 1 to 5 carbon atoms or an aromatic group of 6 to 10 carbon atoms, and m is a positive integer;

tetracarboxylic acid dianhydride; and

diamine;

to polymerization reaction,

wherein a total amount of the compound represented by formula (3) provided that P₅ and P₆ are each independently a monovalent aliphatic hydrocarbon group of 1 to 5 carbon atoms and m is 5, is greater than 0 ppm to 1500 ppm or less based on weights of the compound represented by formula (3) and the silicon-containing compound represented by formula (4).

[12] The resin composition according to any one of [1] to [7], wherein the amide-based solvent is at least one selected from the group consisting of N,N-dimethylformamide (DMF), N,N-dimethylacetamide (DMAc), N-methyl-2-pyrrolidone (NMP), N-methylcaprolactam, tetramethylurea (TMU), β-alkoxypropionamide, and an amide compound represented by formula (5):

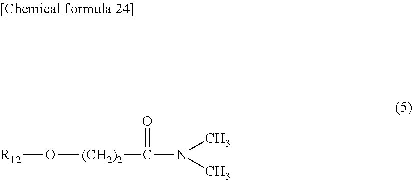

wherein R₁₂ is an alkyl group.
[13] The resin composition according to any one of [1] to [7], wherein the non-amide-based solvent having a boiling point of 160° C. or higher is at least one selected from the group consisting of γ-butyrolactone (GBL), ethyl acetoacetate, 1,3-dimethyl-2-imidazolidinone, dimethyl sulfoxide, sulfolane, diisobutyl ketone, 3-methoxy-3-methyl butyl acetate, butyl cellosolve, butyl cellosolve acetate, ethylene glycol, diethylene glycol, diethylene glycol monoethyl ether, diethylene glycol dimethyl ether, diethylene glycol diethyl ether (DMDG), propylene glycol, dipropylene glycol dimethyl ether and dipropylene glycol methyl ether acetate.
[14] The resin composition according to [8] or [9], wherein the tetracarboxylic acid dianhydride is at least one selected from the group consisting of pyromellitic acid dianhydride, 3,3′,4,4′-biphenyltetracarboxylic acid dianhydride, 4,4′-oxydiphthalic acid anhydride, cyclohexanetetracarboxylic acid dianhydride, cyclobutanetetracarboxylic acid dianhydride, 4,4′-(hexafluoroisopropylidene)diphthalic anhydride, 9,9-bis[4-(3,1-, 3,2-, 3,3- or 3,4-dicarboxyphenoxy)phenyl]fluorene dianhydride, norbomane-2-spiro-α-cyclopentanone-α′-spiro-2″-norbomane-5,5″,6,6″-tetracarboxylic acid dianhydride (CpODA), P-phenylene bis(trimellitate anhydride) (TAHQ), and 3,3′,4,4′-diphenyl sulfone tetracarboxylic acid dianhydride (DSDA).
[15] The resin composition according to [8] or [9], wherein the diamine is at least one selected from the group consisting of 4,4′-diamino diphenyl sulfone, m-tolidine, p-phenylene diamine, 2,2′-bis(trifluoromethyl)benzidine, 2,2′-bis[4-(4-aminophenoxy)phenyl]propane, cyclohexanediamine and 4,4′-diaminodicyclohexylmethane.
[16] The resin composition according to [8] or [9], wherein the resin composition is subjected to vacuum distillation in a step of reducing the compound represented by formula (3) which is contained in the silicon-containing compound represented by formula (4).
[17] The resin composition according to [8] or [9], wherein the resin composition is allowed to stand for 2 to 12 hours under conditions of 200° C. to 300° C. and 300 Pa or lower in a step of reducing the compound represented by formula (3) which is contained in the silicon-containing compound represented by formula (4).
[18] The resin composition according to any one of [1] to [9] and [12] to [17], wherein the resin composition is allowed to stand under a condition of vacuum of 100 Pa or lower in a step of removing the solvent from the resin composition or a step of curing the resin composition to obtain polyimide.
[19] The resin composition according to any one of [1] to [9] and [12] to [18], wherein the resin composition is heated by far-infrared rays in a step of curing the resin composition to obtain polyimide.
[20] A resin composition comprising:

a polyimide precursor containing:
a structure unit represented by formula (1):

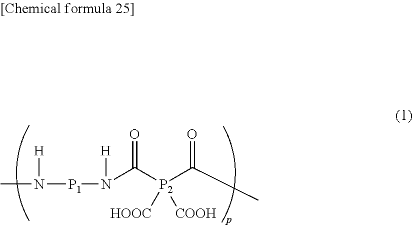

wherein, P₁ represents a divalent organic group, P₂ represents a tetravalent organic group, and p is a positive integer, and
a structure unit represented by formula (2):

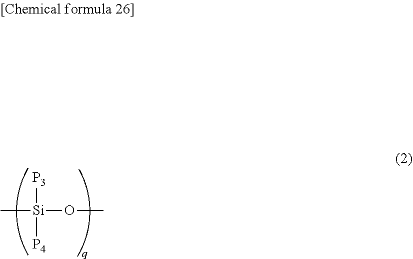

wherein P₃ and P₄ are each independently a monovalent aliphatic hydrocarbon group of 1 to 5 carbon atoms or a monovalent aromatic group of 6 to 10 carbon atoms, and q is a positive integer;

a compound represented by formula (3):

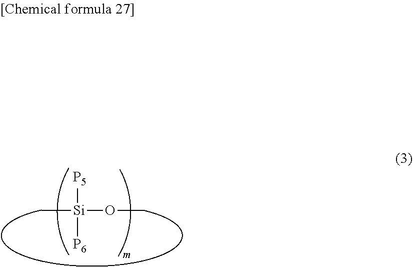

wherein P₅ and P₆ are each independently a monovalent aliphatic hydrocarbon group of 1 to 5 carbon atoms or an aromatic group of 6 to 10 carbon atoms, and m is a positive integer;

an amide-based solvent; and

a silicon aggregation inhibitor;

wherein a total amount of the compound represented by formula (3) provided that P₅ and P₆ are each independently a monovalent aliphatic hydrocarbon group of 1 to 5 carbon atoms and m is 5, is greater than 0 ppm to 35 ppm or less based on a weight of the resin composition, or greater than 0 ppm to 300 ppm or less based on a solid content weight of the resin composition.

[21] The resin composition according to any one of [1] to [9] and [12] to [20], wherein a polyimide resin film which is obtained by curing the polyimide precursor is used for a flexible substrate.
[22] The resin composition according to any one of [1] to [9] and [12] to [21], wherein a polyimide resin film which is obtained by curing the polyimide precursor is used for a flexible display.
[23] A method of preparing a polyimide film, comprising:

a coating step of coating a surface of a support with the resin composition according to any one of [1] to [9] and [12] to [22],

a film forming step of forming a polyimide resin film by heating the resin composition, and

a stripping step of stripping the polyimide resin film from the support.

[24] The method according to [23], which comprises an irradiation step of irradiating a laser to the resin composition from the support side, prior to the stripping step.
[25] A method of preparing a display, comprising:

a coating step of coating a surface of a support with the resin composition according to any one of [1] to [9] and [12] to [22],

a film forming step of forming a polyimide resin film by heating the resin composition,

an element forming step of forming an element on the polyimide resin film, and

a stripping step of stripping the polyimide resin film on which the element from the support was formed.

[26] A method of preparing a laminate, comprising:

a coating step of coating a surface of a support with the resin composition according to any one of [1] to [9] and [12] to [22],

a film forming step of forming a polyimide resin film by heating the resin composition, and

an element forming step of forming an element on the polyimide resin film.

[27] The method according to [26], which further comprises a stripping step of stripping the polyimide resin film on which the element is formed, from the support.
[28] A method of preparing a flexible device, comprising the step of preparing the laminate by the method according to [26] or [27].
[29] A polyimide film, which is a cured product of the resin composition according to any one of [1] to [9] and [12] to [22].

The polyimide film or polyimide resin film according to the present invention enables to improve transparency thereof. More specifically, the polyimide film or polyimide resin film of the present invention enables to reduce haze and reduce a foreign substance attached to a coating film while suppressing the retardation and the YI value to the level as high as or higher than that of the prior art.

### BRIEF DESCRIPTION OF THE DRAWINGS

FIG. 1 is a schematic diagram illustrating a structure of a Top-emission flexible organic EL display, which is an upper portion of a polyimide substrate, as an example of a display of the present embodiment.

### DETAILED DESCRIPTION OF THE INVENTION

Embodiments for carrying out the invention (hereunder referred to as “the present embodiment”) will be explained below in more detail. It is to be understood, however, that the invention is not limited to the following embodiments and may implement various modifications within the scope of the gist thereof. Furthermore, in the present description an upper limit and lower limit for ranges of various characteristic values may be arbitrarily combined.

<<Resin Composition>>

### <Polyimide Precursor>

### Structure Unit of Formula (1)

The resin composition of the present embodiment comprises a polyimide precursor containing the structure unit represented by formula (1):

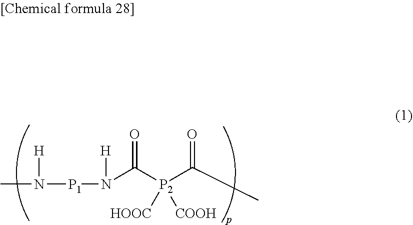

{wherein, P₁ represents a divalent organic group, P₂ represents a tetravalent organic group, and p is a positive integer}. The polyimide precursor having the structure represented by formula (1) is preferably a copolymer of acid dianhydride having the P₂ group and the diamine having the P₁ group.

Acid Dianhydride

As the acid dianhydride containing the P₂ group, examples thereof include pyromellitic dianhydride, 3,3′,4,4′-biphenyltetracarboxylic dianhydride, 2,2′,3,3′-biphenyltetracarboxylic dianhydride, 4,4′-(hexafluoroisopropylidene)diphthalic anhydride (6FDA), 5-(2,5-dioxotetrahydro-3-furanyl)-3-methyl-cyclohexene-1,2-dicarboxylic anhydride, 1,2,3,4-benzenetetracarboxylic dianhydride, 3,3′,4,4′-benzophenonetetracarboxylic dianhydride, 2,2′,3,3′-benzophenonetetracarboxylic dianhydride, 3,3′,4,4′-diphenyl sulfonetetracarboxylic dianhydride (DSDA), methylene-4,4′-diphthalic dianhydride, 1,1-ethylidene-4,4′-diphthalic dianhydride, 2,2-propylidene-4,4′-diphthalic dianhydride, 1,2-ethylene-4,4′-diphthalic dianhydride, 1,3-trimethylene-4,4′-diphthalic dianhydride, 1,4-tetramethylene-4,4′-diphthalic dianhydride, 1,5-pentamethylene-4,4′-diphthalic dianhydride, 4,4′-oxydiphthalic dianhydride (ODPA), p-phenylene bis(trimellitate anhydride) (TAHQ), thio-4,4′-diphthalic dianhydride, sulfonyl-4,4′-diphthalic dianhydride, 1,3-bis(3,4-dicarboxyphenyl)benzene dianhydride, 1,3-bis(3,4-dicarboxyphenoxy)benzene dianhydride, 1,4-bis(3,4-dicarboxyphenoxy)benzene dianhydride, 1,3-bis[2-(3,4-dicarboxyphenyl)-2-propyl]benzene dianhydride, 1,4-bis[2-(3,4-dicarboxyphenyl)-2-propyl]benzene dianhydride, bis[3-(3,4-dicarboxyphenoxy)phenyl]methane dianhydride, bis[4-(3,4-dicarboxyphenoxy)phenyl]methane dianhydride, 2,2-bis[3-(3,4-dicarboxyphenoxy)phenyl]propane dianhydride, 2,2-bis[4-(3,4-dicarboxyphenoxy)phenyl]propane dianhydride, bis(3,4-dicarboxyphenoxy)dimethylsilane dianhydride, 1,3-bis(3,4-dicarboxyphenyl)-1,1,3,3-tetramethyldisiloxane dianhydride, 2,3,6,7-naphthalenetetracarboxylic dianhydride, 1,4,5,8-naphthalene tetracarboxylic dianhydride, 1,2,5,6-naphthalene tetracarboxylic dianhydride, 3,4,9,10-perylene tetracarboxylic dianhydride, 2,3,6,7-anthracenetetracarboxylic dianhydride, cyclobutane tetracarboxylic dianhydrides (for example, 1,2,3,4-cyclobutane tetracarboxylic dianhydride, 1,2,3,4-tetramethyl-1,2,3,4-cyclobutanetetracarboxylic dianhydride, etc.), cyclohexane tetracarboxylic dianhydrides (for example, 1,2,4,5-cyclohexanetetracarboxylic dianhydride, etc.), 9,9-bis[4-(3,1-, 3,2-, 3,3- or 3,4-dicarboxyphenoxy)phenyl]fluorene dianhydride, norbomane-2-spiro-α-cyclopentanone-α′-spiro-2″-norbomane-5,5″,6,6″-tetracarboxylic dianhydride (CpODA), 1,2,7,8-phenanthrene tetracarboxylic dianhydride, etc.

Among these, from the viewpoint of reducing film haze and foreign substances attached to a coating film, at least one compound selected from the group consisting of pyromellitic dianhydride, 3,3′,4,4′-biphenyltetracarboxylic dianhydride, 4,4′-oxydiphthalic anhydride, cyclohexane tetracarboxylic dianhydride, cyclobutane tetracarboxylic dianhydride, 4,4′-(hexafluoroisopropylidene)diphthalic anhydride (6FDA), 9,9-bis[4-(3,1-, 3,2-, 3,3- or 3,4-dicarboxyphenoxy)phenyl]fluorene dianhydride, norbomane-2-spiro-α-cyclopentanone-α′-spiro-2″-norbomane-5,5″,6,6″-tetracarboxylic dianhydride (CpODA), P-phenylenebis(trimelitate anhydride) (TAHQ), and 3,3′,4,4′-diphenyl sulfone tetracarboxylic dianhydride (DSDA), is preferred.

As the acid dianhydride, one compound thereof may be used alone, or two or more compounds may be used in combination. Among these combinations, pyromellitic dianhydride (PMDA) and biphenyltetracarboxylic dianhydride (BPDA) are preferred from the standpoint of mechanical properties, optical properties such as low retardation (Rth) in thickness direction, low yellowness (YI value), etc., as well as a high glass transition temperature of the polyimide film. It is more preferable that the polyimide precursor having the structure represented by formula (1) is a copolymer of tetracarboxylic acid dianhydride and diamine, and the tetracarboxylic acid dianhydride contains pyromellitic dianhydride (PMDA).

The total content of pyromellitic dianhydride (PMDA) and biphenyltetracarboxylic dianhydride (BPDA) in all acid dianhydrides is preferably 60% by mole or more, more preferably 80% by mole or more, and still more preferably 100% by mole, from the viewpoint of the low Rth and YI value as well as the high glass transition temperature of the polyimide film.

From the viewpoint of the high glass transition temperature of the polyimide film, the content of pyromellitic dianhydride (PMDA) in all acid dianhydrides is preferably 0% by mole or more, preferably 10% by mole or more, preferably 20% by mole or more, preferably 100% by mole or less, or preferably 90% by mole or less.

From the viewpoint of the low Rth and YI value of the polyimide film, the content of biphenyltetracarboxylic dianhydride (BPDA) in all acid dianhydrides is preferably 0% by mole or more, preferably 10% by mole or more, preferably 20% by mole or more, preferably 100% by mole or less, or 90% by mole or less.

From the standpoint of compatibility of the low Rth and YI value, higher glass transition temperature, elongation, etc., of the polyimide film, the content ratio of pyromellitic dianhydride (PMDA):biphenyltetracarboxylic dianhydride (BPDA) in acid dianhydrides is preferably 20:80 to 80:20, and more preferably 30:70 to 70:30.

Diamine

As the diamine containing the P₁ group in formula (1), examples thereof include diaminodiphenyl sulfone (for example, 4,4′-diaminodiphenyl sulfone, 3,3′-diaminodiphenyl sulfone), p-phenylenediamine, m-phenylenediamine, 4,4′-diaminodiphenyl sulfide, 3,4′-diaminodiphenyl sulfide, 3,3′-diaminodiphenyl sulfide, 4,4′-diaminobiphenyl, 3,4′-diaminobiphenyl, 3,3′-diaminobiphenyl, 2,2′-bis(trifluoromethyl)benzidine (alias: 4,4′-diamino-2,2′-bis(trifluoromethyl)biphenyl), m-tolidine (alias: 4,4′-diamino-2,2′-dimethylbiphenyl), 4,4′-diaminobenzophenone, 3,4′-diaminobenzophenone, 3,3′-diaminobenzophenone, 4,4′-diaminodiphenylmethane, 3,4′-diaminodiphenylmethane, 3,3′-diaminodiphenylmethane, 1,4-bis(4-aminophenoxy)benzene, 1,3-bis(4-aminophenoxy)benzene, 1,3-bis(3-aminophenoxy)benzene, bis[4-(4-aminophenoxy)phenyl]sulfone, 4,4-bis(4-aminophenoxy)biphenyl, 4,4-bis(3-aminophenoxy)biphenyl, bis[4-(4-aminophenoxy)phenyl] ether, bis[4-(3-aminophenoxy)phenyl]ether, 1,4-bis(4-aminophenyl)benzene, 1,3-bis(4-aminophenyl)benzene, 9,10-bis(4-aminophenyl)anthracene, 2,2-bis(4-aminophenyl)propane, 2,2-bis(4-aminophenyl)hexafluoropropane, 2,2-bis[4-(4-aminophenoxy)phenyl]propane, 2,2-bis[4-(4-aminophenoxy)phenyl]hexafluoropropane, cyclohexanediamine (for example, 1,4-cyclohexanediamine, 1,2-cyclohexanediamine, and a cis- or trans-isomer or mixture of cis-isomer and trans-isomer, etc.), 4,4′-diaminodicyclohexylmethane (for example, product name “WONDAMINE” manufactured by New Japan Chemical Co., Ltd., etc.), 1,4-bis(3-aminopropyldimethylsilyl)benzene, etc.

Among these, from the viewpoint of reducing the YI value and haze of the film, at least one selected from the group consisting of 4,4′-diaminodiphenyl sulfone, m-tolidine, p-phenylenediamine, 2,2′-bis(trifluoromethyl)benzidine, 2,2′-bis[4-(4-aminophenoxy)phenyl]propane, cyclohexanediamine and 4,4′-diaminodicyclohexylmethane, is preferred.

The diamine containing the P₁ group in formula (1) preferably contains diaminodiphenyl sulfone (DAS), for example 4,4′-diaminodiphenyl sulfone, and/or 3,3′-diaminodiphenyl sulfone.

The content of diaminodiphenyl sulfone in all diamines may be 50% by mole or more, or 70% by mole or more, or 90% by mole or more, or 95% by mole or more. It is preferable that the greater the amount of diaminodiphenyl sulfone is, the lower the YI value of the polyimide film becomes and the higher the glass transition temperature thereof is. As the diaminodiphenyl sulfone, 4,4′-diaminodiphenyl sulfone is particularly preferable from the viewpoint of reducing the YI value.

The diamines may be used alone or two or more may be used in combination. It is preferred to copolymerize diaminodiphenyl sulfone with other diamines. Other diamines to be copolymerized with diaminodiphenyl sulfone include preferably diamidobiphenyls, more preferably diaminobis(trifluoromethyl)biphenyl (TFMB) from the viewpoint of high heat resistance and low YI value of the polyimide film. The content of diaminobis(trifluoromethyl)biphenyl (TFMB) in all diamines is preferably 20% by mole or more, and more preferably 30% by mole or more from the viewpoint of the low YI value of the polyimide film. From the standpoint of the design that allows the diamine to include other advantageous diamines such as diaminodiphenyl sulfone, etc., the content of TFMB is preferably 80% by mole or less, and more preferably 70% by mole or less.

Structure Unit of Formula (2)

The polyimide precursor in the resin composition according to the present embodiment further comprises the structure unit represented by formula (2):

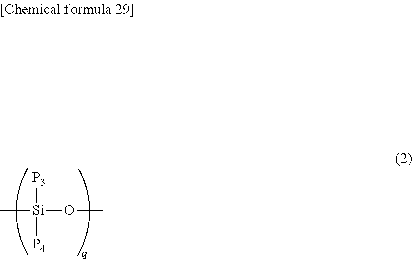

{wherein, P₃ and P₄ are each independently a monovalent aliphatic hydrocarbon group of 1 to 5 carbon atoms or a monovalent aromatic group of 6 to 10 carbon atoms, and q is a positive integer.}.

Based on the weight of the polyimide precursor, the lower limit of the ratio of the structure portion represented by formula (2) is preferably 5% by weight or more, more preferably 6% by weight or more, and further preferably 7% by weight or more from the viewpoint of reducing the residual stress of the polyimide film that is generated with the support. The upper limit of the ratio of the structure portion represented by formula (2) is preferably 40% by weight or less, more preferably 30% by weight or less, and further preferably 25% by weight or less based on the weight of the polyimide precursor, from the viewpoint of the transparency and heat resistance of the polyimide film.

In the above formula (2), q is a positive integer, and it is preferably 1 to 200 and more preferably 3 to 200, from the viewpoint of the heat resistance of the polyimide obtained.

The polyimide precursor may have the structure portion represented by formula (2) at any position in the molecule, but from the viewpoint of the type of siloxane monomer, cost and molecular weight of the polyimide precursor obtained, the structure represented by formula (2) is preferably derived from a silicon-containing compound such as a silicon-containing diamine. As the silicon-containing diamine, for example, diamino (poly)siloxane represented by the following formula (6):

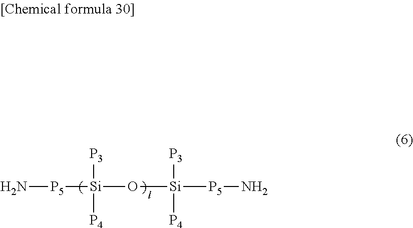

{wherein, P₅ each independently represents a divalent hydrocarbon group, which may be the same or different, P₃ and P₄ are the same as those defined in formula (2), and 1 is an integer of 1 to 200.}, is preferred.

As a preferable structure of P₅ in formula (6), a methylene group, ethylene group, propylene group, butylene group, phenylene group, etc., are included. Moreover, as a preferable structure of P₃ and P₄, a methyl group, ethyl group, propyl group, butyl group, phenyl group, etc., are included. In formula (6), 1 is an integer of 1 to 200, and it is preferably an integer of 3 to 200 from the viewpoint of the heat resistance of the polyimide obtained using the compound represented by formula (6).

The number-average molecular weight of the compound represented by formula (6) is preferably 500 or more, more preferably 1,000 or more, and further preferably 2,000 or more from the viewpoint of reducing the residual stress generated between the obtained polyimide film and the support. The number-average molecular weight is preferably 12,000 or less, more preferably 10,000 or less, and still more preferably 8,000 or less from the viewpoint of the transparency (particularly low haze) of the polyimide film obtained.

As the compound represented by formula (6), specific examples thereof include a both amine end-modified methylphenyl silicone oil (number-average molecular weight of 4400 or number-average molecular weight of 1300), both amine end-modified dimethyl silicone (number-average molecular weight of 1600, number-average molecular weight of 3000, or number-average molecular weight of 4400), “BY16-835U” manufactured by Dow Corning Toray Co., Ltd. (both amine end-modified dimethyl silicone with number-average molecular weight of 900), “Silaplane FM3311” manufactured by Chisso Corporation (both amine end-modified dimethyl silicone with number-average molecular weight of 1000), both acid anhydride end-modified methyl phenyl silicone oil (number-average molecular weight of 4200), etc. Among these, from the viewpoint of improving chemical resistance and Tg, the both amine end-modified methylphenyl silicone oil is preferred.

The copolymerization ratio of the silicon-containing diamine is preferably 0.5 to 30% by weight, more preferably 1.0% by weight to 25% by weight, and still more preferably 1.5% by weight to 20% by weight, based on the total weight of the polyimide precursor. When the silicon-containing diamine is 0.5% by weight or more, the residual stress generated with the support can be effectively reduced. Moreover, when the silicon-containing diamine is 30% by weight or less, the transparency (particularly low HAZE) of the obtained polyimide film is favorable, and it is preferable from the viewpoint of achieving high total light transmittance and high glass transition temperature.

Dicarboxylic Acid

As an acid component for forming the polyimide precursor in the present embodiment, in addition to the acid dianhydride (for example, the tetracarboxylic dianhydride listed above), dicarboxylic acid can be added within a range that does not impair performance thereof. Namely, the polyimide precursor in the present disclosure may be a polyamideimide precursor. A film obtained from such a polyamideimide precursor may have favorable properties such as mechanical elongation, glass transition temperature Tg, YI value, etc. As the dicarboxylic acid to be used, dicarboxylic acid having an aromatic ring and alicyclic dicarboxylic acid are included. In particular at least one compound selected from the group consisting of aromatic dicarboxylic acid having 8 to 36 carbon atoms and alicyclic dicarboxylic acid having 6 to 34 carbon atoms, is preferred. Note that the number of carbon atoms referred to herein includes the number of carbon atoms contained in the carboxy group. Among these, dicarboxylic acid having an aromatic ring is preferred.

As the dicarboxylic acid having an aromatic ring, examples thereof include, isophthalic acid, terephthalic acid, 4,4′-biphenyldicarboxylic acid, 3,4′-biphenyldicarboxylic acid, 3,3′-biphenyldicarboxylic acid, 1,4-naphthalenedicarboxylic acid, 2,3-naphthalenedicarboxylic acid, 1,5-naphthalenedicarboxylic acid, 2,6-naphthalenedicarboxylic acid, 4,4′-sulfonylbisbenzoic acid, 3,4′-sulfonylbisbenzoic acid, 3,3′-sulfonylbisbenzoic acid, 4,4′-oxybisbenzoic acid, 3,4′-oxybisbenzoic acid, 3,3′-oxybisbenzoic acid, 2,2-bis(4-carboxyphenyl)propane, 2,2-bis(3-carboxyphenyl)propane, 2,2′-dimethyl-4,4′-biphenyldicarboxylic acid, 3,3′-dimethyl-4,4′-biphenyldicarboxylic acid, 2,2′-dimethyl-3,3′-biphenyldicarboxylic acid, 9,9-bis(4-(4-carboxyphenoxy)phenyl)fluorene, 9,9-bis(4-(3-carboxyphenoxy)phenyl)fluorene, 4,4′-bis(4-carboxyphenoxy)biphenyl, 4,4′-bis(3-carboxyphenoxy)biphenyl, 3,4′-bis(4-carboxyphenoxy)biphenyl, 3,4′-bis(3-carboxyphenoxy)biphenyl, 3,3′-bis(4-carboxyphenoxy)biphenyl, 3,3′-bis(3-carboxyphenoxy)biphenyl, 4,4′-bis(4-carboxyphenoxy)-p-terphenyl, 4,4′-bis(4-carboxyphenoxy)-m-terphenyl, 3,4′-bis(4-carboxyphenoxy)-p-terphenyl, 3,3′-bis(4-carboxyphenoxy)-p-terphenyl, 3,4′-bis(4-carboxyphenoxy)-m-terphenyl, 3,3′-bis(4-carboxyphenoxy)-m-terphenyl, 4,4′-bis(3-carboxyphenoxy)-p-terphenyl, 4,4′-bis(3-carboxyphenoxy)-m-terphenyl, 3,4′-bis(3-carboxyphenoxy)-p-terphenyl, 3,3′-bis(3-carboxyphenoxy)-p-terphenyl, 3,4′-bis(3-carboxyphenoxy)-m-terphenyl, 3,3′-bis(3-carboxyphenoxy)-m-terphenyl, 1,1-cyclobutanedicarboxylic acid, 1,4-cyclohexanedicarboxylic acid, 1,2-cyclohexanedicarboxylic acid, 4,4′-benzophenonedicarboxylic acid, 1,3-phenylenediacetic acid, 1,4-phenylenediacetic acid, etc.; 5-aminoisophthalic acid derivatives described in WO2005/068535, etc. When these dicarboxylic acids are actually copolymerized into a polymer, these may be used in the form of an acid chloride compound formed using thionyl chloride, etc., and active ester compound, etc.

The polyimide precursor in the resin composition can be a copolymer comprising as a monomer unit a silicon-containing compound represented by formula (4):

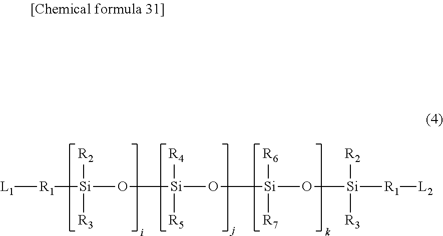

{wherein, R₁ is each independently single bond or a divalent organic group of 1 to 10 carbon atoms, R₂ and R₃ are each independently a monovalent aliphatic hydrocarbon group of 1 to 5 carbon atoms, R₄ and R₅ are each independently a monovalent aromatic group of 6 to 10 carbon atoms, R₆ and R₇ are each independently a monovalent organic group of 1 to 10 carbon atoms, at least one of R₆ and R₇ is an organic group having an unsaturated aliphatic hydrocarbon group, L₁ and L₂ are each independently an amino group, an acid anhydride group, an isocyanate group, a carboxy group, an acid ester group, an acid halide group, a hydroxy group, an epoxy group or a mercapto group, i is an integer of 1 to 200, and j and k are each independently an integer of 0 to 200.}; tetracarboxylic acid dianhydride, and diamine, and/or when the total amount of the silicon-containing compound represented by formula (4), the tetracarboxylic acid dianhydride and the diamine is 100 parts, the content of the silicon-containing compound represented by formula (4) in the resin composition can be 5% by weight or more and 30% by weight or less.

Although L₁ and L₂ of the silicon-containing compound represented by the above formula (4) are not limited, these may be each independently an amino group or an acid anhydride group from the viewpoint of the molecular weight of the obtained polyimide precursor, and are each more preferably the amino group from the viewpoint of the molecular weight of the polyimide precursor.

In formula (4), R₁ each independently represents single bond or a divalent organic group of 1 to 10 carbon atoms. The divalent organic group of 1 to 10 carbon atoms may be linear, cyclic or branched, and may be saturated or unsaturated. Examples of the divalent aliphatic hydrocarbon group of 1 to 10 carbon atoms include linear or branched alkylene chains, such as methylene, ethylene, n-propylene, i-propylene, n-butylene, s-butylene, t-butylene, n-pentylene, neopentylene, n-hexylene, n-heptylene, n-octylene, n-nonylene, n-decylene group, etc.; and cycloalkylene groups such as cyclopropylene, cyclobutylene, cyclopentylene, cyclohexylene, cycloheptylene, cyclooctylene group, etc. As the divalent aliphatic hydrocarbon group of 1 to 10 carbon atoms, at least one selected from the group consisting of ethylene, n-propylene and i-propylene is preferred.

In formula (4), R₂ and R₃ are each independently a monovalent organic group having 1 to 10 carbon atoms, and at least one thereof is a monovalent aliphatic hydrocarbon group having 1 to 5 carbon atoms. The monovalent organic group having 1 to 10 carbon atoms may be linear, cyclic or branched, and may be saturated or unsaturated. As the monovalent organic group having 1 to 10 carbon atoms, examples thereof include linear or branched alkyl groups, such as methyl, ethyl, n-propyl, i-propyl, n-butyl, s-butyl, t-butyl, n-pentyl, neopentyl, n-hexyl, n-heptyl, n-octyl, n-nonyl, n-decyl group, etc.; cycloalkyl groups such as cyclopropyl, cyclobutyl, cyclopentyl, cyclohexyl, cycloheptyl, cyclooctyl group, etc., and aromatic groups such as phenyl, tolyl, xylyl, α-naphthyl, β-naphthyl group, etc. The monovalent aliphatic hydrocarbon group having 1 to 5 carbon atoms may be linear, cyclic or branched, and may be saturated or unsaturated. As the monovalent aliphatic hydrocarbon group having 1 to 5 carbon atoms, examples thereof include linear or branched alkyl groups such as methyl, ethyl, n-propyl, i-propyl, n-butyl, s-butyl, t-butyl, n-pentyl, neopentyl group, etc.; and cycloalkyl groups such as cyclopropyl, cyclobutyl, cyclopentyl group, etc. As the monovalent aliphatic hydrocarbon group having 1 to 5 carbon atoms, at least one selected from the group consisting of methyl, ethyl and n-propyl is preferred.

In formula (4), R₄ and R₅ are each independently a monovalent organic group having 1 to 10 carbon atoms, and at least one is a monovalent aromatic group having 6 to 10 carbon atoms. The monovalent organic group having 1 to 10 carbon atoms may be linear, cyclic or branched, and may be saturated or unsaturated. As the monovalent organic group having 1 to 10 carbon atoms, examples thereof include linear or branched alkyl groups such as methyl, ethyl, n-propyl, i-propyl, n-butyl, s-butyl, t-butyl, n-pentyl, neopentyl, n-hexyl, n-heptyl, n-octyl, n-nonyl, n-decyl group, etc.; cycloalkyl groups such as cyclopropyl, cyclobutyl, cyclopentyl, cyclohexyl, cycloheptyl, cyclooctyl group, etc., and aromatic groups such as phenyl, tolyl, xylyl, α-naphthyl, β-naphthyl group, etc. Examples of the monovalent aromatic group having 6 to 10 carbon atoms include phenyl, tolyl, xylyl, α-naphthyl, β-naphthyl group, etc., with phenyl, tolyl or xylyl being preferred.

In formula (4), R₆ and R₇ are each independently a monovalent organic group of 1 to 10 carbon atoms, and at least one is an organic group having an unsaturated aliphatic hydrocarbon group. The monovalent organic group of 1 to 10 carbon atoms may be linear, cyclic or branched, and examples thereof include linear or branched alkyl groups such as methyl, ethyl, n-propyl, i-propyl, n-butyl and s-butyl, t-butyl, n-pentyl, neopentyl, n-hexyl, n-heptyl, n-octyl, n-nonyl, n-decyl group, etc.; cycloalkyl groups such as cyclopropyl, cyclobutyl, cyclopentyl, cyclohexyl, cycloheptyl, cyclooctyl group, etc.; and aromatic groups such as phenyl, tolyl, xylyl, α-naphthyl, β-naphthyl group, etc. As the monovalent organic group of 1 to 10 carbon atoms, at least one selected from the group consisting of methyl, ethyl and phenyl is preferred. The organic group having an unsaturated aliphatic hydrocarbon group may be an unsaturated aliphatic hydrocarbon group of 3 to 10 carbon atoms, and may be linear, cyclic or branched. Examples of the unsaturated aliphatic hydrocarbon group of 3 to 10 carbon atoms include vinyl, allyl, propenyl, 3-butenyl, 2-butenyl, pentenyl, cyclopentenyl, hexenyl, cyclohexenyl, heptenyl, octenyl, nonenyl, decenyl, ethynyl, propynyl, butynyl, pentynyl, hexynyl group, etc. The unsaturated aliphatic hydrocarbon group of 3 to 10 carbon atoms is preferably at least one selected from the group consisting of vinyl, allyl and 3-butenyl.

In formula (4), some or all of the hydrogen atoms of R₁ to R₇ may be substituted by a substituent such as a halogen atom including F, Cl or Br, etc., or these may be unsubstituted.

The subscript i is an integer of 1 to 200, preferably an integer of 2 to 100, more preferably an integer of 4 to 80, and still more preferably an integer of 8 to 40. The subscripts j and k are each independently an integer of 0 to 200, preferably an integer of 0 to 50, more preferably an integer of 0 to 20, and still more preferably an integer of 0 to 50.

In the copolymer, the tetracarboxylic dianhydride and the diamine contained as monomer units together with the silicon-containing compound represented by formula (4) may be the tetracarboxylic dianhydride and the diamine listed in regard to formula (1), respectively.

Weight-Average Molecular Weight

In the present embodiment, the weight-average molecular weight of the polyimide precursor is preferably 50,000 or more, and more preferably 60,000 or more, from the viewpoint of reducing the YI value of the polyimide film. Moreover, from the viewpoint of reducing the haze of the polyimide film, the weight-average molecular weight of the polyimide precursor is preferably 150,000 or less, and more preferably 120,000 or less. The desired weight-average molecular weight of the polyimide precursor may vary depending on the desired application, type of polyimide precursor, solid content weight of the resin composition, type of solvents that may be contained in the resin composition, etc.

Preferred Embodiment of Polyimide Precursor

As particularly preferred polyimide precursor in the present embodiment, examples thereof include the following (1) to (18).

(1) A polycondensate wherein the acid dianhydride component is biphenyl tetracarboxylic dianhydride (BPDA) and the diamine component is diaminodiphenyl sulfone (DAS) and the silicon-containing diamine.

(2) A polycondensate wherein the acid dianhydride component is BPDA and the diamine component is fluorene diamine and the silicon-containing diamine.

(3) A polycondensate wherein the acid dianhydride component is BPDA and the diamine component is cyclohexanediamine and the silicon-containing diamine.

(4) A polycondensate wherein the acid dianhydride component is BPDA and the diamine component is 4,4′-diaminodicyclohexylmethane (“WONDAMINE”, product name) and the silicon-containing diamine.

(5) A polycondensate wherein the acid dianhydride component is pyromellitic dianhydride (PMDA) and the diamine component is DAS and the silicon-containing diamine.

(6) A polycondensate wherein the acid dianhydride component is pyromellitic dianhydride (PMDA) and the diamine component is DAS, diaminobis(trifluoromethyl)biphenyl (TFMB) and the silicon containing diamine.

(7) A polycondensate wherein the acid dianhydride component is 4,4′-oxydiphthalic dianhydride (ODPA) and the diamine component is DAS and the silicon-containing diamine.

(8) A polycondensate wherein the acid dianhydride component is 4,4′-(hexafluoroisopropylidene)diphthalic anhydride (6FDA) and the diamine component is DAS and the silicon-containing diamine.

(9) A polycondensate wherein the acid dianhydride component is cyclohexanetetracarboxylic dianhydride (HPMDA) and the diamine component is DAS and the silicon-containing diamine.

(10) A polycondensate wherein the acid dianhydride component is HPMDA and the diamine component is TFMB and the silicon-containing diamine.

(11) A polycondensate wherein the acid dianhydride component is 9,9-bis[4-(3,1-, 3,2-, 3,3- or 3,4-dicarboxyphenoxy)phenyl]fluorene dianhydride, and the diamine component is DAS and the silicon-containing diamine.

(12) A polycondensate wherein the acid dianhydride component is 9,9-bis[4-(3,1-, 3,2-, 3,3- or 3,4-dicarboxyphenoxy)phenyl]fluorene dianhydride, and the diamine component is TFMB and the silicon-containing diamine.

(13) A polycondensate wherein the acid dianhydride component is norbomane-2-spiro-α-cyclopentanone-α′-spiro-2″-norbomane-5,5″,6,6″-tetracarboxylic dianhydride (CpODA) and the diamine component is DAS and the silicon-containing diamine.

(14) A polycondensate wherein the acid dianhydride component is CpODA and the diamine component is TFMB and the silicon-containing diamine.

(15) A polycondensate wherein the acid dianhydride component is P-phenylene bis(trimellitate anhydride) (TAHQ) and the diamine component is DAS and the silicon-containing diamine.

(16) A polycondensate wherein the acid dianhydride component is 3,3′,4,4′-diphenyl sulfone tetracarboxylic dianhydride (DSDA) and the diamine component is DAS and the silicon-containing diamine.

(17) A polycondensate wherein the acid dianhydride component is DSDA and the diamine component is TFMB and the silicon-containing diamine.

(18) A polycondensate wherein the acid dianhydride component is BPDA and PMDA, and the diamine component is DAS and the silicon-containing diamine.

In the material components of the polycondensates of the above (1) to (18), the silicon-containing diamine is preferably diamino (poly)siloxane represented by the above formula (6). In this case, the number-average molecular weight of the diamino (poly)siloxane is preferably 500 to 12,000, and more preferably a both amine end-modified methylphenyl silicone oil.

<Cyclic Siloxane>

### Compound of Formula (3)

From the viewpoint of improvement of the transparency and the reduction of the haze, the resin composition preferably contains the compound represented by the following formula (3):

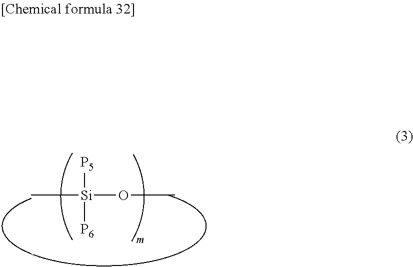

{wherein, P₅ and P₆ are each independently a monovalent aliphatic hydrocarbon group of 1 to 5 carbon atoms or an aromatic group of 6 to 10 carbon atoms, and m is a positive integer.} in a specific proportion. Surprisingly, when the compound represented by formula (3), which has conventionally been considered to have to be removed by purification, is present only in trace amounts in the polyimide silicone, it has been found to contribute to improve the transparency, i.e., to reduce the haze. From the same viewpoint, in formula (3), m is preferably 3 or more, and more preferably 3 to 8 or 3 to 6.

From the viewpoint of improving the transparency and reducing the haze, or from the viewpoint of reducing foreign substances that adhere to the polyimide (PI) film after curing, the compound of formula (3) is contained in the resin composition in an amount of greater than 0 ppm to 1200 ppm or less, preferably 100 to 1192 ppm, more preferably 200 to 1017 ppm based on the weight of the resin composition, and/or it is contained in the resin composition in an amount of preferably greater than 0 ppm and 7500 ppm or less, and more preferably 100 ppm or more and 7442 ppm or less based on the solid content weight of the resin composition.

Moreover, from the viewpoint of improving the transparency and reducing the haze, or from the viewpoint of reducing foreign substances adhering to the PI film after curing, the compound wherein P₅ and P₆ are each independently an aromatic group of 6 to 10 carbon atoms and m is 3 in formula (3), is contained in the resin composition (i) in an amount of greater than 0 ppm and 700 ppm or less, preferably 10 to 691 ppm, and more preferably 20 to 650 ppm based on the weight of the resin composition, and/or it is contained in the resin composition (ii) in an amount of greater than 0 ppm and 5000 ppm or less, preferably 100 to 4923 ppm, and more preferably 200 to 4000 ppm, based on the solid content weight of the resin composition, and/or it is contained in the resin composition (iii) in an amount of greater than 0 ppm to 25000 ppm or less, preferably 100 to 24886 ppm, and more preferably 200 to 24000 ppm based on the total weight of the compounds represented by formulas (3) and (4).

Further, from the viewpoint of improving the transparency and reducing the haze, or from the viewpoint of reducing foreign substances adhering to the PI film after curing, the compound wherein P₅ and P₆ are each independently a monovalent aliphatic hydrocarbon group of 1 to 5 carbon atoms and m is 5 in formula (3), is contained in the resin composition (i) in an amount of greater than 0 ppm and 35 ppm or less, preferably 1 to 34 ppm, and more preferably 2 to 32 ppm based on the weight of the resin composition, and/or it is contained in the resin composition (ii) in an amount of greater than 0 ppm and 300 ppm or less, preferably 10 to 280 ppm, and more preferably 20 to 259 ppm, based on the solid content weight of the resin composition, and/or it is contained in the resin composition (iii) in an amount of greater than 0 ppm to 1500 ppm or less, preferably 10 to 1300 ppm, 10 to 1000 ppm or 10 to 959 ppm and more preferably 20 to 943 ppm based on the total weight of the compounds represented by formulas (3) and (4).

In the present description, “solid content” refers to all components other than the solvent in the resin composition, and liquid monomer components are also included in the solid content weight. When the resin composition comprises only the solvent and the polyimide precursor, the polyimide precursor corresponds to the solid content. When the resin composition comprises only the solvent and the polyimide precursor, the solid content weight corresponds to the total weight of all the monomers contained in the polyimide precursor. The solid content weight can also be determined by subtracting the weight of the solvent from the weight of the resin composition after determining the weight of the solvent by gas chromatography (hereinafter also referred to as GC) analysis of the resin composition.

The compound represented by formula (3) may contain, for example, the cyclic compound (hereinafter often referred to as “low molecular weight cyclic siloxane”) represented by the following formulas (7-1) and (7-2) (hereinafter, both formulas are simply referred to as formula (7)), or the cyclic compound represented by the following formula (8). The resin composition may comprise one, two or all of the compounds represented by formulas (7-1), (7-2) and (8).

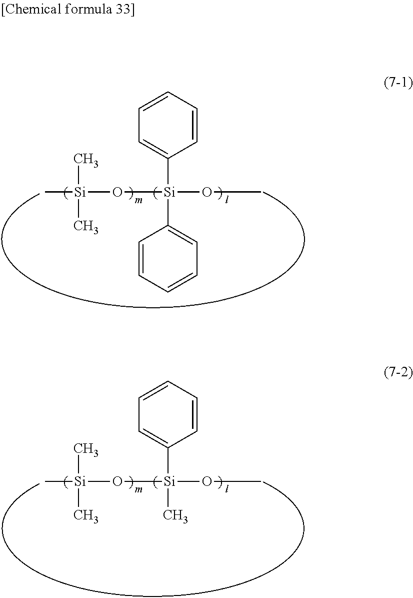

{wherein, m is an integer of 1 or more, preferably an integer of 3 to 5. Note that the subscript of (Si—O) is numeral 1.}

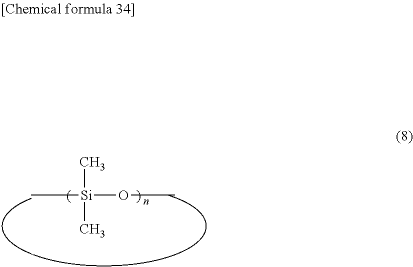

{wherein n is an integer of 2 or larger, preferably an integer of 3 to 8.}.

The content of the compound represented by formula (7) wherein m is 3, is preferably greater than 0 ppm to 700 ppm or less, more preferably greater than 0 ppm to 500 ppm or less, and still more preferably greater than 0 ppm to 300 ppm or less based on the weight of the resin composition, from the viewpoint of the foreign substances adhering to the PI film after curing.

From the same viewpoint, with respect to the weight of the solid content in the resin composition, the content of the compound represented by formula (7) provided that m is 3, is preferably greater than 0 ppm and 5000 ppm or less, more preferably greater than 0 ppm and 3000 ppm or less, and still more preferably greater than 0 ppm and 1000 ppm or less.

From the same point of view, relative to the weights of the silicon-containing compounds represented by formulas (3) and (4), the content of the compound represented by formula (7) (wherein m is 3), is preferably greater than 0 ppm and 25000 ppm or less, more preferably greater than 0 ppm and 20000 ppm or less, and still more preferably greater than 0 ppm and 10000 ppm or less.

The content of the compound represented by formula (7) provided m is an integer of 3 or more is, from the viewpoint of the foreign substances that adhere to the PI film after curing, preferably greater than 0 ppm and 1200 ppm or less, more preferably greater than 0 ppm and 1000 ppm or less, and still more preferably greater than 0 ppm and 800 ppm or less based on the weight of the resin composition.

From the same viewpoint, when the content of the compound represented by formula (7) provided m is an integer of 3 or more, is based on the solid content weight of the resin composition, it is preferably greater than 0 ppm and 7500 ppm or less, more preferably greater than 0 ppm to 5000 ppm or less, and still more preferably greater than 0 ppm to 3000 ppm or less.

From the same viewpoint, when the content of the compound represented by formula (7) wherein m is an integer of 3 or more, is based on the weights of the silicon-containing compounds of formulas (3) and (4), it is preferably greater than 0 ppm and 46000 ppm or less, more preferably greater than 0 ppm and 30000 ppm or less, and still more preferably greater than 0 ppm and 20000 ppm or less.

The content of the compound represented by formula (8) (wherein n is 5), is preferably greater than 0 ppm and 35 ppm or less, more preferably greater than 0 ppm to 30 ppm or less, and further preferably greater than 0 ppm to 20 ppm or less based on the weight of the resin composition, from the viewpoint of the foreign substances that adhere to the PI film after curing.

From the same point of view, with respect to the solid content weight in the resin composition, the content of the compound represented by formula (8) wherein n is 5, is preferably greater than 0 ppm and 300 ppm or less, more preferably greater than 0 ppm and 250 ppm or less, and still more preferably greater than 0 ppm and 200 ppm or less.

From the same viewpoint, relative to the weights of silicon-containing compounds of formulas (3) and (4), the content of the compound represented by formula (8) wherein n is 5, is preferably greater than 0 ppm and 1000 ppm or less, or greater than 0 ppm and 1500 ppm or less, more preferably greater than 0 ppm and 900 ppm or less, and still more preferably greater than 0 ppm and 800 ppm or less.

Reduction of Foreign Substance

On the basis of each weight of the resin composition, solid content, and silicon-containing compound, the smaller the total amount of the cyclic siloxane (preferably m=3 to 5) of formula (7) and the cyclic siloxane (preferably n=3 to 8) of formula (8) is, the smaller the amount of foreign substances attached in the manufacturing step of the polyimide resin film becomes, which is preferable. Although the mechanism thereof is unknown, the present inventors conjecture as follows: Namely, in the manufacturing step of the polyimide resin film, as one aspect, a surface of a support such as a glass substrate, etc., is coated with the resin composition comprising a polyimide precursor composition, and the resin composition is heated for example, at 100° C. for 30 minutes in an oven to remove the solvent followed by continuously heating in the same oven at more elevated temperatures, for example, 350° C. for 1 hour to form a polyimide resin film through imidization. Here, the cyclic siloxane of formula (8) is more volatile than the cyclic siloxane of formula (7) while even in the case of the cyclic siloxane of formula (8) wherein for example, m is 5 or more, the molecular weight thereof becomes large, and thereby it hardly volatilizes. Therefore, when removing the solvent, the cyclic siloxane having a small number of m in formula (8) is volatilized and in the case of the imidization, the cyclic siloxanes having the number of m being large in formulas (7) and formula (8) are volatilized and eventually adhered in the oven. In particular, it is also conjectured that when samples in large numbers are fed into the oven, more cyclic siloxanes of formula (7) and formula (8) are deposited in the oven, and then fall off on the polyimide resin film as foreign substances adhering thereto. Thus, it is preferred that the amount of the foreign substances be reduced as much as possible from the viewpoint of the amount of the foreign substances adhered in the manufacturing step.

<Solvent>

The resin composition typically comprises a solvent. The solvent having favorable solubility for the polyimide precursor and capable of appropriately controlling a solution viscosity of the resin composition is preferable, and the solvent that is used for the preparation of the polyimide precursor may be used as the solvent of the composition.

### First Embodiment

### Solvent Mixture

In the first embodiment, the solvent of the resin composition is a mixture of an amide-based solvent and a non-amide-based solvent having a boiling point of 160° C. or higher. A resin composition comprising the polyimide precursor in this mixture is preferable from the viewpoint of the haze of the obtained polyimide film and foreign substances observed after coating with the polyimide precursor composition. Although the reason is not clear, it is surmised as follows.

{Haze Value}

The first reason is surmised that although the single amide-based solvent and the single non-amide-based solvent are each independently not highly compatible with the siloxane-based polyimide precursor according to the present invention (the solubility parameters are not similar), in the case of the mixture of the amide-based and non-amide-based solvents, the solubility parameter of the mixture becomes close to that of the siloxane-based polyimide precursor, thereby improving the solubility.

The second reason, it is comprehended that when using a far-infrared (IR) heating furnace to cure the polyimide precursor, the inside of the object is also efficiently heated, and even a high-boiling point solvent having a boiling point of 160° C. or higher volatilizes and does not remain in the polyimide resin precursor coating film, thereby improving the haze of the polyimide film.

Mixing Ratio

In regard to the mixing weight ratio of the amide-based solvent to the non-amide-based solvent having a boiling point of 160° C. or higher may be, the ratio of amide-based solvent:non-amide-based solvent having a boiling point of 160° C. or higher is 10:90 to 90:10.

Amide-Based Solvent

As the amide-based solvent, at least one selected from the group consisting of N, N-dimethylformamide (DMF), N, N-dimethylacetamide (DMAc), N-methyl-2-pyrrolidone (NMP), N-methylcaprolactam, tetramethylurea, β-alkoxypropionamide, the amide-based compounds represented by the following formula (5):

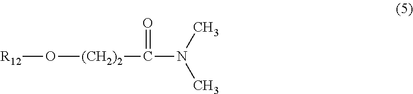

{wherein, R₁₂ is an alkyl group}, and for example, Equamide M100 (trade name) wherein R₁₂=a methyl group in the above formula (5), manufactured by Idemitsu Kosan Co., Ltd. and Equamide B100 (trade name) wherein R₁₂=n-butyl group in the above formula (5), manufactured by Idemitsu Kosan Co., Ltd., may be used.

Non-amide-based Solvent Having Boiling Point of 160° C. or Higher

As the non-amide-based solvent having a boiling point of 160° C. or higher, at least one selected from the group consisting of for example, γ-butyrolactone (GBL), ethyl acetoacetate, 1,3-dimethyl-2-imidazolidinone (DMI), dimethyl sulfoxide (DMSO), sulfolane, diisobutyl ketone (DIBK), 3-methoxy-3-methylbutyl acetate, butyl cellosolve, butyl cellosolve acetate, ethylene glycol, diethylene glycol, diethylene glycol monoethyl ether, diethylene glycol dimethyl ether (alias: diglyme), diethylene glycol diethyl ether (DGDE), propylene glycol, dipropylene glycol dimethyl ether and dipropylene glycol methyl ether acetate, may be used.

Other Solvent

The resin composition may comprise, in addition to the amide-based solvent and the non-amide-based solvent having a boiling point of 160° C. or higher, if desired, other solvents such as tetrahydrofuran (THF), acetonitrile, propylene glycol monomethyl ether (PGME), propylene glycol monomethyl ether acetate (PGMEA), ethyl lactate, cyclopentanone, amyl acetate, ethylene glycol monoethyl ether, propylene glycol monomethyl ether acetate, etc.

<Silicon Aggregation Inhibitor>

### Second Embodiment

In the second embodiment, the resin composition comprises a silicon aggregation inhibitor, the polyimide precursor including the structure unit represented by formula (1) and the structure unit represented by formula (2), the compound represented by formula (3) that is contained in the preferred amount as described above, and the amide-based solvent. The polyimide precursor composition comprising the silicon aggregation inhibitor tends to reduce the haze and/or retardation of the resulting polyimide film. The reason therefor is not clear, but it is surmised that the compound represented by formula (3) that is contained in the preferred amount functions as a compatibilizer in the resin composition, and the silicon aggregation inhibitor suppresses aggregation of the siloxane units of the polyamide silicone with each other and aggregation of a plurality of silicon atoms contained in the compound represented by formula (3), and then controls the particle size of the silicon-containing substance in the film to about 100 nm or less, thereby preventing light scattering and ensuring transparency.

For the same reason, as the silicon aggregation inhibitor, for example, diethylene glycol diethyl ether (DGDE), γ-butyrolactone (GBL), ethyl acetoacetate, 1,3-dimethyl-2-imidazolidinone (DMI), dimethyl sulfoxide (DMSO), sulfolane, diisobutyl ketone (DIBK), 3-methoxy-3-methylbutyl acetate, butyl cellosolve, butyl cellosolve acetate, diethylene glycol, diethylene glycol monoethyl ether, diethylene glycol diethyl ether, propylene glycol, diethylene glycol dimethyl ether, dipropylene glycol dimethyl ether, dipropylene glycol methyl ether acetate, etc., can be used.

<Additional Component>

The resin composition of the present embodiment may further comprise additional components such as a surfactant, an alkoxysilane compound, etc., in addition to the components described above.

<<Resin Composition Manufacturing Method>>

The method for manufacturing a resin composition in the present embodiment is not specifically restricted, and for example, it can be produced based on the following method.

<Adjustment of Content of Silicon-Containing Compound>

The resin composition of the present embodiment can be manufactured by subjecting polycondensation components including the acid dianhydride, the diamine, and the silicon-containing compound to a polycondensation reaction. As a method for adjusting a total amount of the compounds represented by formula (3) comprised in the resin composition of this embodiment, a method such as purifying the silicon-containing compound prior to the polycondensation reaction to control the total amount of the compound represented by formula (3), is included. Alternatively, after the polycondensation reaction, the resin composition may be purified to control the total amount of the compound represented by formula (3). In any case, the total amount of the compound represented by formula (3) in the polyimide precursor composition is adjusted to be greater than 0 ppm. From the same viewpoint, a method for manufacturing a resin composition comprising a step of providing the polyimide precursor obtained by subjecting the silicon-containing compounds containing the structures represented by formulas (3) and (4) described above, tetracarboxylic dianhydride and diamine, to a polycondensation reaction, is also another aspect of the present invention. In the method for manufacturing the resin composition, (i) the total amount of the compounds in formula (3) wherein P₅ and P₆ are each independently an aromatic group of 6 to 10 carbon atoms and m is 3, can be adjusted to greater than 0 ppm and 25000 ppm or less based on the weights of the compounds represented by formulas (3) and (4), or (ii) the total amount of the compounds in formula (3) wherein P₅ and P₆ are each independently a monovalent aliphatic hydrocarbon group of 1 to 5 carbon atoms and m is 5, can be adjusted to greater than 0 ppm and 1000 ppm or less based on the weight of the compounds represented by formulas (3) and (4).

As a purification method of the silicon-containing compound, for example, a method such as carrying out stripping while blowing an inert gas such as nitrogen gas into the silicon-containing compound in an arbitrary container, is included. The temperature for stripping is preferably 150° C. or higher and 300° C. or lower, more preferably 160° C. or higher and 300° C. or lower, and still more preferably 200° C. or higher and 300° C. or lower. The vapor pressure of stripping is preferably as low as possible, and it is preferably 1000 Pa or lower, more preferably 300 Pa or lower, still more preferably 200 Pa or less, and furthermore preferably 133.32 Pa (1 mmHg) or lower. The stripping time is preferably 2 hours or longer to 12 hours or shorter, more preferably 4 hours or longer to 12 hours or shorter, and still more preferably 6 hours or longer to 10 hours or shorter. By adjusting to the aforementioned conditions, the total amount of the compounds represented by formula (3) can be controlled in a preferable range. Also in the step of reducing the amount of the compounds represented by formula (3) contained in the silicon-containing compound represented by formula (4), it is preferable to subject the resin composition to distillation under reduced pressure, and/or, to allow the resin composition to stand under the conditions of 200° C. to 300° C. and 300 Pa or lower for 2 hours to 12 hours.

<Synthesis of Polyimide Precursor>

The polyimide precursor of this embodiment can be synthesized by subjecting polycondensation components comprising the acid dianhydride, diamine, and silicon-containing compound to a polycondensation reaction. As the silicon-containing compound, it is preferable to use the aforementioned purified one. In a preferred aspect, the polycondensation components consist of the acid dianhydride, diamine and silicon-containing compound. The polycondensation reaction is preferably carried out in a suitable solvent. Specifically, for example, a method for dissolving a prescribed amount of the diamine component and the silicon-containing compound in a solvent, followed by adding a prescribed amount of the acid dianhydride to the obtained diamine solution with stirring, is included.

The molar ratio of the acid dianhydride and the diamine when synthesizing the polyimide precursor is, from the viewpoint of increasing the molecular weight of the polyimide precursor resin and the slit coating characteristics of the resin composition, the ratio of acid dianhydride:diamine is 100:90 to 100:110 (0.90 to 1.10 mole parts of the diamine with respect to 1 mole part of the acid dianhydride) is preferred, and the ratio of 100:95 to 100:105 (0.95 to 1.05 mole parts of the diamine per 1 mole part of the acid dianhydride) is more preferred.

The molecular weight of the polyimide precursor can be controlled by the types of acid the dianhydride, diamine and silicon-containing compound, adjustment of the molar ratio between the acid dianhydride and the diamine, addition of an end capping agent, adjustment of reaction conditions, etc. The polyimide precursor can highly be polymerized as the molar ratio of acid dianhydride component:diamine component is closer to 1:1 and as the use amount of the end capping agent is smaller.

It is recommended to use a high purity product as the acid dianhydride component and the diamine component. The purity thereof is each preferably 98% by weight or higher, more preferably 99% by weight or higher, and still more preferably 99.5% by weight or higher. Purification can also be achieved by reducing the water content of the acid dianhydride component and diamine component. When a plurality of acid dianhydride components and/or a plurality of diamine components are used, it is preferred to attain the aforementioned purity as the whole acid dianhydride components and the whole diamine components, and each of all the types of the acid dianhydride components and the diamine components used more preferably has the aforementioned purity.

In the case of the embodiment according to the present application, basically, the solvent for the reaction is used as the solvent contained in the resin composition. Therefore, as the solvent for the reaction, a mixture of the amide-based solvent and the non-amide-based solvent having a boiling point of 160° C. or higher can be used.

In another aspect, a solvent that can dissolve the acid dianhydride component, the diamine component and the resulting polyimide precursor, and is capable of providing a polymer having a high molecular weight, can be used. Examples of such a solvent include an aprotic solvent, phenol-based solvent, ether-based or glycol-based solvent, etc.

As the aprotic solvent, examples thereof include the following solvents:

Amide-based solvents such as N, N-dimethylformamide (DMF), N, N-dimethylacetamide (DMAc), N-methyl-2-pyrrolidone (NMP), N-methylcaprolactam, tetramethylurea, the amide-based compounds represented by the above formula (5), etc.;

Lactone-based solvents such as γ-butyrolactone, γ-valerolactone, etc.;

Phosphorus-containing amide-based solvents such as hexamethyl phosphoric amide, hexamethyl phosphine triamide, etc.;

Sulfur-containing solvents such as dimethyl sulfone, dimethyl sulfoxide, sulfolane, etc.;

Ketone-based solvents such as cyclohexanone, methyl cyclohexanone, etc.;

Tertiary amine-based solvents such as picolin, pyridine, etc.;

Ester-based solvents such as (2-methoxy-1-methylethyl) acetate, etc.

Examples of the phenol-based solvents include phenol, o-cresol, m-cresol, p-cresol, 2,3-xylenol, 2,4-xylenol, 2,5-xylenol, 2,6-xylenol, 3,4-xylenol, 3,5-xylenol, etc.

As ether- and glycol-based solvents, for example, 1,2-dimethoxyethane, bis(2-methoxyethyl)ether, 1,2-bis(2-methoxyethoxy)ethane, bis[2-(2-methoxyethoxy)ethyl]ether, tetrahydrofuran, 1,4-dioxane, etc., are included.

These solvents may be used alone or in combination of two or more.

The water content in the solvent is preferably, for example, 3,000 ppm by weight or less in order to allow the polycondensation reaction to proceed well. Moreover, in the resin composition of the present embodiment, the content of molecules having a molecular weight of less than 1,000 is preferably less than 5% by weight. The reason for the presence of the molecule having a molecular weight of less than 1,000 in the resin composition is considered to be attributed to the water content of the solvent or the raw materials (acid dianhydride, diamine) used during the synthesis. Namely, it is conjectured because the acid anhydride groups of the acid dianhydride monomer are partially hydrolyzed by water to generate a carboxy group and remains as a low molecular fraction without propagation to a high molecular weight polymer. Therefore, the water content of the solvent used for the polycondensation reaction is preferably as small as possible. The water content of the solvent is preferably 3,000 ppm by weight or less, and more preferably 1,000 ppm by weight or less. Similarly, the amount of water contained in the raw materials is also preferably 3,000 ppm by weight or less, and more preferably 1,000 ppm by weight or less.

The water content of the solvent is probably associated with grades of the solvent used (dehydration grade, general purpose grade, etc.), solvent containers (bottle, 18 L can, canister can etc.), storage conditions of the solvent (with or without rare gas-filling, etc.), a period of time from opening to use (whether used immediately after opening or used after an elapsed of time after opening, etc.). Moreover, the water content may also be associated with noble gas substitution in a reactor before synthesis, and with rare gas circulation during synthesis, etc. Therefore, when synthesizing the polyimide precursor, it is recommended to use a high purity product as raw materials and use a solvent with a small amount of water, and to take measures so that water from the environment is not mixed with the reaction system before and during the reaction.

When dissolving each polycondensation component in a solvent, it may be heated if necessary. From the viewpoint of obtaining a polyimide precursor having a high degree of polymerization, the reaction temperature during the synthesis of the polyimide precursor may be preferably 0° C. to 120° C., 40° C. to 100° C. or 60 to 100° C. and the polymerization time may be preferably 1 to 100 hours, or 2 to 10 hours. By setting the polymerization time to 1 hour or longer, a polyimide precursor having a uniform degree of polymerization can be obtained, and by setting the polymerization time to 100 hours or shorter, a polyimide precursor having a high degree of polymerization can be obtained.

The resin composition of the present embodiment may comprise other additional polyimide precursors in addition to the polyimide precursor of the present embodiment. However, the weight ratio of the additional polyimide precursor is preferably 30% by weight or less and more preferably 10% by weight or less with respect to the total amount of the polyimide precursors in the resin composition from the viewpoint of reducing the oxygen dependency of YI value and total light transmittance of the polyimide film.

The polyimide precursor in the present embodiment may be partially imidized (partial imidization). When it is partially imidized, it is possible to improve the viscosity stability when storing the resin composition. The imidization ratio in this case is preferably 5% or more and more preferably 8% or more, preferably 80% or less, more preferably 70% or less, and further preferably 50% or less from the viewpoint of balance of the solubility of the polyimide precursor in the resin composition with the storage stability of the solution. This partial imidization is attained by heating the polyimide precursor followed by cyclodehydration thereof. This heating treatment can be carried out at a temperature of preferably 120 to 200° C., and more preferably 150 to 180° C., and can be carried out preferably for 15 minutes to 20 hours, and more preferably for 30 minutes to 10 hours.

The compound in which the carboxylic acid groups are partially or totally esterified by adding N, N-dimethylformamide dimethyl acetal or N, N-dimethylformamide diethyl acetal to the polyamic acid obtained by the above reaction followed by heating, can be used as the polyimide precursor of the present embodiment. The esterification can improve viscosity stability during storage. These ester-modified polyamic acids can also be obtained by a method for sequentially reacting the aforementioned acid dianhydride component with one equivalent of a monohydric alcohol relative to the acid anhydride group, and with a dehydration condensation agent such as thionyl chloride or dicyclohexylcarbodiimide, etc., followed by the condensation reaction with a diamine component.

<Preparation of Resin Composition>

The solvent comprised in the resin composition according to the first or second embodiment can be a solvent for reaction used for the synthesis of the polyimide precursor. The amide-based solvent and/or the non-amide-based solvent having a boiling point of 160° C. or higher that are used when synthesizing the polyimide precursor, can directly be used as a solvent for the resin composition. When the solvent for reaction is either the amide-based solvent or the non-amide-based solvent having a boiling point of 160° C. or higher, another solvent may be added and mixed after the preparation of the polyimide precursor, and then the mixture is stirred to obtain the resin composition of the first embodiment. The resin composition according to the second embodiment can also be obtained by adding and mixing a silicon aggregation inhibitor after preparation of the polyimide precursor. The stirring and mixing can be carried out using an appropriate means such as a three-one motor (manufactured by Shinto Kagaku Co., Ltd.) equipped with stirring blades, a rotation and revolution mixer, etc. The resin composition may be heated to 40° C. to 100° C. as necessary.

When the solvent that is used when synthesizing the polyimide precursor and the solvent to be contained in the resin composition are different, the solvent in the solution of the synthesized polyimide precursor may be removed to isolate the polyimide precursor by an appropriate method such as reprecipitation, solvent evaporation, etc. Then, in a temperature range of room temperature (25° C.) to 80° C., the amide-based solvent, the non-amide-based solvent having a boiling point of 160° C. or higher or the silicon aggregation inhibitor, and the additional component as desired, are added to the isolated polyimide precursor followed by mixing and stirring together to prepare the resin composition according to the first or second embodiment.

After preparing the resin composition as described above, the polyimide precursor may partially be subjected to dehydration imidization (partial imidization) by heating the resin composition to such an extent that a polymer does not precipitate, for example, at 130 to 200° C., for example, for 5 minutes to 2 hours. The imidization ratio can be controlled by setting the heating temperature and the heating time. By partial imidization of the polyimide precursor, it is possible to improve the viscosity stability when storing the resin composition.

The solution viscosity of the resin composition is preferably 500 to 100,000 mPa·s, more preferably 1,000 to 50,000 mPa·s, and still more preferably 3,000 to 20,000 mPa·s, from the viewpoint of slit coating performance. Specifically, the viscosity is preferably 500 mPa·s or higher, more preferably 1,000 mPa·s or higher, and still more preferably 3,000 mPa·s or higher, in terms of preventing liquid leakage from the slit nozzle. In addition, it is preferably 100,000 mPa·s or lower, more preferably 50,000 mPa·s or lower, and still more preferably 20,000 mPa·s or lower, in terms of suppressing nozzle clogging.

Moreover, regarding the solution viscosity of the resin composition at the time of polyimide precursor synthesis, when it is higher than 200,000 mPa·s, there may arise a problem of difficulty in stirring during synthesis. However, even if the solution has a high viscosity at the time of synthesis, it is possible to obtain a resin composition having a handleable viscosity by adding a solvent and stirring after completion of the reaction. The solution viscosity of the resin composition in the present embodiment is a value measured at 23° C. using an E-type viscometer (for example, VISCONICEHD, manufactured by Toki Sangyo Co., Ltd.).

The water content of the resin composition of the present embodiment is preferably 3,000 ppm by weight or less, more preferably 2,500 ppm by weight or less, still more preferably 2,000 ppm by weight or less, furthermore preferably 1,500 ppm by weight or less, particularly preferably 1,000 ppm by weight or less, particularly preferably 500 ppm by weight or less, particularly preferably 300 ppm by weight or less, or particularly preferably 100 ppm by weight or less, from the viewpoint of viscosity stability when storing the resin composition.

<<Polyimide Film and Manufacturing Method Thereof>>

A polyimide film (hereinafter, also referred to as a polyimide resin film) can be provided using the resin composition of the present embodiment. The method for manufacturing the polyimide film of the present embodiment includes: a coating step of coating a surface of a support with the resin composition of the present embodiment; a film forming step of forming a polyimide resin film by heating the aforementioned resin composition; and a stripping step of stripping the aforementioned polyimide resin film from the support.

<Coating Step>

In the coating step, a surface of a support is coated with the resin composition of the present embodiment. The support is not particularly limited provided that it has heat resistance for the heating temperatures in the subsequent film forming step (heating step) and exhibits a favorable stripping property in the stripping step. As the support, examples thereof include a glass substrate, for example, an alkali-free glass substrate; a silicon wafer; resin substrates such as PET (polyethylene terephthalate), OPP (oriented polypropylene), polyethylene glycol terephthalate, polyethylene glycol naphthalate, polycarbonate, polyimide, polyamideimide, polyether imide, polyether ether ketone, polyether sulfone, polyphenylene sulfone, polyphenylene sulfide, etc.; metal substrates such as stainless steel, alumina, copper, nickel, etc.

When forming a thin polyimide film, for example, a glass substrate, silicon wafer, etc., are preferred, and when forming a thick polyimide film or polyimide sheet, for example, PET (polyethylene terephthalate), OPP (oriented polypropylene), etc., are preferred.

Coating methods generally include coating means such as a doctor blade knife coater, air knife coater, roll coater, rotary coater, flow coater, die coater, bar coater, etc., coating methods such as spin coating, spray coating, dip coating, etc., and printing techniques as representative of screen printing, gravure printing, etc. Among these, coating by slit coating is preferable for the resin composition of the present embodiment. The coating thickness ought to be appropriately adjusted according to the desired thickness of the resin film and the content of the polyimide precursor in the resin composition, and it is preferably about 1 to 1,000 μm. The temperature in the coating step may be room temperature, and the resin composition may be heated, for example, to 40 to 80° C. to lower the viscosity and improve the workability.

<Optional Drying Process>

A drying process may be carried out following the coating process, or the drying process may be omitted and directly proceed to the next film forming process (heating process). The drying step can be carried out by allowing the resin composition to stand under the condition of vacuum of 100 Pa or less for the purpose of removing the organic solvent in the resin composition. When carrying out the drying, for example, appropriate devices such as a hot plate, box dryer, conveyor dryer, etc., can be used. The temperature of the drying step is preferably 80 to 200° C. and more preferably 100 to 150° C. The implementation time of the drying step is preferably 1 minute to 10 hours and more preferably 3 minutes to 5 hours. As in the manner described above, the coating film containing the polyimide precursor is formed on a support.

<Film Forming Process>

Subsequently, a film forming step (heating step) is carried out. The heating step is, in addition to a step of removing the organic solvent contained in the aforementioned coating film, a step of proceeding the imidization reaction of the polyimide precursor in the coating film to obtain a polyimide resin film. This heating step can be carried out by allowing the resin composition to stand under the vacuum of 100 Pa or less using an apparatus such as an inert gas oven, hot plate, box dryer, conveyor dryer, etc. This step may be carried out simultaneously with the drying step, or both steps may be carried out sequentially.

The heating step may be carried out in an air atmosphere, but from the viewpoint of safety, favorable transparency of the obtained polyimide film, low retardation (Rth) in thickness direction and low YI value of the polyimide film, it is preferably carried out under an inert gas atmosphere. Examples of the inert gas include nitrogen, argon, etc. The heating temperature may be appropriately set depending on a type of the polyimide precursor and a type of solvent in the resin composition, but is preferably 250° C. to 550° C. and more preferably 300 to 450° C. If the temperature is 250° C. or higher, the imidization reaction favorably proceeds, and if the temperature is 550° C. or lower, inconveniences such as decrease in transparency of the obtained polyimide film and deterioration of heat resistance, etc., can be avoided. The heating time is preferably about 0.1 to 10 hours.

In the present embodiment, the oxygen concentration in the ambient atmosphere in the above heating step is preferably 2,000 ppm by weight or less, more preferably 100 ppm by weight or less, and still more preferably 10 ppm or less from the viewpoint of the transparency and YI value of the obtained polyimide film. By heating in an atmosphere with an oxygen concentration of 2,000 ppm by weight or less, the YI value of the obtained polyimide film can be 30 or less.

{Film Thickness Uniformity of Polyimide Precursor Coating Film Following Heated Vacuum Drying (HVCD)}

In the step of removing the solvent from the coating film of the PI precursor composition, heated vacuum drying (HVCD) can be employed. In the HVCD, the solvent is removed by heating under the vacuum of about 100 Pa. Therefore, it is conjectured that among the mixture of the solvents according to the first embodiment, when the boiling point of the non-amide-based solvent is low, the amount of the solvent removed in this step is large, and the in-plane uniformity of the coating film of the polyimide precursor composition after this step becomes worse. Moreover, it is also surmised that in this step, the low molecular weight cyclic siloxane that is contained in the composition also vaporizes and is removed together with the solvent, and when a purified (reduced amount of the low molecular weight cyclic siloxane) silicon-containing compound is used as a raw material for the polyimide precursor, the amount of the low molecular weight cyclic siloxane to be removed is also small, and thus the in-plane uniformity of the coating film of the polyimide precursor composition after this step has been improved.

<Stripping Step>

In the striping step, the polyimide resin film on a support is stripped, for example, after being cooled to about room temperature (25° C.) to 50° C. Examples of this stripping step include the following aspects (i) to (iv).

(i) A method for preparing the constituent comprising the polyimide resin film/support by the above method, irradiating a laser from the support side of the constituent for ablation processing of the interface between the support and the polyimide resin film to strip off the polyimide resin. The type of the laser includes a solid (YAG) laser, a gas (UV excimer) laser, etc. It is preferable to use a spectrum such as a wavelength of 308 nm (see, for example, Japanese Translation of PCT International Application Publication No. JP-T-2007-512568, Japanese Translation of PCT International Application Publication No. JP-T-2012-511173, etc.).

(ii) A method for forming a stripping layer on a support before coating a surface of the support with the resin composition, fabricating a constituent comprising the polyimide resin film/stripping layer/support, and then stripping off the polyimide resin film. The stripping layer may be, for example, parylene (registered trademark, manufactured by Parylene Japan K.K) or tungsten oxide, and releasing agents such as a vegetable oil-based, silicone-based, fluorine-based or alkyd-based agent, etc., may be used (see, for example, Japanese Unexamined Patent Application No. 2010-067957, Japanese Unexamined Patent Application No. 2013-179306, etc.).

This method (ii) may be employed in combination with the laser irradiation of the method (i).

(iii) A method for fabricating a constituent comprising the polyimide resin film/support using a metal substrate that can be etched as a support, followed by etching the metal with an etchant to obtain the polyimide resin film. As the metal, for example, copper (as a specific example, electrolytic copper foil “DFF” manufactured by Mitsui Mining & Smelting Co., Ltd.), aluminum, etc., can be used. As the etchant, ferric chloride, etc., can be used for copper, and dilute hydrochloric acid, etc., can be used for aluminum.

(iv) A method for fabricating a constituent comprising the polyimide resin film/support by the above method, attaching an adhesive film on the surface of the polyimide resin film, and separating the adhesive film/the polyimide resin film from the support followed by separation of the adhesive film from the polyimide resin film.

Among these stripping methods, the method (i) or (ii) is preferable from the viewpoint of the refractive index difference between the front and back of the obtained polyimide resin film, the YI value, and the elongation. It is more preferable to carry out the method (i), i.e., the irradiation step of irradiating the laser from the support side prior to the stripping step, from the viewpoint of the refractive index difference between the front and back of the polyimide resin film obtained. Additionally, in the method (iii), when copper is used as a support, the YI value of the obtained polyimide resin film becomes large and the elongation tends to be small. This is considered to be due to the effect of copper ions.

The thickness of the resulting polyimide film is not restricted but is preferably 1 to 200 μm and more preferably 5 to 100 μm.

<Yellowness (YI Value)>

The YI value for a 10 μm thickness film of the polyimide film obtained from the resin composition of the present embodiment is preferably 20 or less, more preferably 18 or less, still more preferably 16 or less, particularly preferably 14 or less, particularly preferably 13 or less, particularly preferably 10 or less, or particularly preferably 7 or less from the viewpoint of obtaining favorable optical properties. Moreover, the YI value varies depending on a monomer backbone of the polyimide precursor, but if monomer backbones each are identical, the larger the weight-average molecular weight of the polyimide precursor is, the smaller the YI value tends to be. Furthermore, the polyimide precursor in which the total amount of the compounds represented by formulas (7) and/or (8) is within the range described above, tends to have a lower YI value of the resulting polyimide resin film, compared to that of the polyimide precursor in which an unpurified silicon-containing compound having the same amine value is used.

<<Applications of Polyimide Film>>

The polyimide film obtained from the resin composition of the present embodiment can be applied to, for example, a semiconductor dielectric film, a thin film transistor liquid crystal display (TFT-LCD) insulating film, and an electrode protective film, and additionally to transparent substrates, etc., of display devices such as a liquid crystal display, an organic electroluminescent display, a field emission display, an electronic paper, etc. In particular, the polyimide film obtained from the resin composition of the present embodiment is suitably used as a thin film transistor (TFT) substrate, a color filter substrate, a touch panel substrate, and a substrate of a transparent conductive film (ITO, Indium Thin Oxide) in the manufacture of flexible devices. As flexible devices to which the polyimide film in this embodiment can be applied, for example, a TFT device for flexible displays, a flexible solar cell, a flexible touch panel, a flexible illumination, a flexible battery, a flexible printed circuit, a flexible color filter, a surface cover lens for cellular phones, etc.

The step of fabricating a TFT on a flexible substrate using the polyimide film is typically carried out at a wide range of temperatures from 150 to 650° C. Specifically, when producing a TFT device using amorphous silicon, process temperatures of 250° C. to 350° C. are generally required, and the polyimide film of the present embodiment needs to withstand the temperatures thereof. Specifically, it is necessary to appropriately select a polymer structure having a glass transition temperature and thermal decomposition temperature higher than the process temperatures.

In the case of fabricating a TFT device using a metal oxide semiconductor (IGZO, etc.), process temperatures of 320° C. to 400° C. are generally required, and the polyimide film of the present embodiment needs to withstand the temperatures thereof. Therefore, it is necessary to appropriately select a polymer structure having a glass transition temperature and thermal decomposition temperature higher than the maximum temperature in the TFT fabricating process.

When fabricating a TFT device using low temperature polysilicon (LTPS), process temperatures of 380° C. to 520° C. are generally required, and the polyimide film of the present embodiment needs to withstand the temperatures thereof. Thus, it is necessary to appropriately select a glass transition temperature and thermal decomposition temperature higher than the maximum temperature in the TFT fabricating process.

On the other hand, due to these heat histories, the optical properties (in particular, light transmittance, retardation property and YI value) of the polyimide film tend to deteriorate as they are exposed to elevated temperature processes. However, the polyimide obtained from the polyimide precursor of the present embodiment has favorable optical properties even after such heat histories.

In the following, methods for manufacturing a display and laminate will be explained as application examples of the polyimide film of the present embodiment.

<Display Manufacturing Method>

The method for manufacturing a display in the present embodiment comprises: a coating step of coating a surface of a support with the resin composition of the present embodiment; a film forming step of forming a polyimide resin film by heating the aforementioned resin composition; an element forming step of forming an element on the aforementioned polyimide resin film, and a stripping step of stripping the polyimide resin film on which the aforementioned element was formed from the support.

Examples of Manufacture of Flexible Organic EL Display

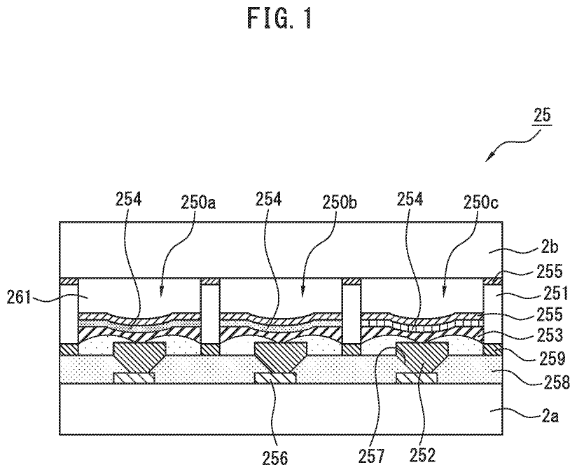

FIG. 1 is a schematic diagram illustrating the structure of the Top-emission flexible organic EL display, which is the upper portion of the polyimide substrate, as an example of the display of the present embodiment.

The organic EL structure unit 25 of FIG. 1 will be explained. For example, the organic EL element 250a that emits red light, the organic EL element 250b that emits green light, and the organic EL element 250c that emits blue light are arranged in the matrix as one unit, and the light emitting area of each organic EL element is separated by each partition wall 251 (bank). Each organic EL element consists of the lower electrode (anode) 252, the hole transport layer 253, the light emitting layer 254, and the upper electrode (cathode) 255. Moreover, on the lower layer 2a that is a CVD multilayer film (multi barrier layer) made of silicon nitride (SiN) and/or silicon oxide (SiO), the TFT 256 (selected from low temperature polysilicon (LTPS) or a metal oxide semiconductor (such as IGZO, etc.)) for driving the organic EL elements, the interlayer dielectric film 258 provided with each contact hole 257, and a plurality of the lower electrodes 259, are disposed. The organic EL elements are sealed by the sealing substrate 2b, and the hollow portion 261 is formed between each organic EL element and the sealing substrate 2b.

The step of manufacturing the flexible organic EL display includes a step of fabricating the polyimide film on the glass substrate support to manufacture the organic EL substrate shown in FIG. 1 above the film, a step of manufacturing the sealing substrate, an assembling step of combining and attaching the both substrates, and a stripping step of stripping the organic EL display fabricated on the polyimide film from the glass substrate support.

Publicly known manufacturing steps can be applied to the organic EL substrate manufacturing step, the sealing substrate manufacturing step, and the assembly step. The examples thereof are given below without being limited thereto. Note that the stripping step is the same as the stripping step of the polyimide film as described above.

For example, as referred to FIG. 1, the polyimide film is first prepared on the glass substrate support by the above method, and the multi-barrier layer (lower substrate 2a in FIG. 1) consisting of the double layer of silicon nitride (SiN) and silicon oxide (SiO) is fabricated thereon by a CVD method or sputtering method followed by fabrication of the metal wiring layer for driving a TFT thereon using a photoresist, etc. The active buffer layer of SiO, etc., is fabricated thereon by the CVD method, and the TFT device (TFT 256 in FIG. 1) such as a metal oxide semiconductor (IGZO) or low temperature polysilicon (LTPS), etc., is fabricated thereon. After fabricating the TFT substrate for the flexible display, the interlayer dielectric film 258 provided with contact holes 257 is formed using a photosensitive acrylic resin, etc. The ITO film is formed by sputtering, etc., and the lower electrode 259 is formed so as to be a counterpart of the TFT.

Next, after each partition (bank) 251 is formed by a photosensitive polyimide, etc., the hole transport layer 253 and the light emitting layer 254 are formed in each space separated by the partition. Further, the upper electrode (cathode) 255 is formed so as to cover the light emitting layer 254 and the partitions (banks) 251. Thereafter, using a fine metal mask, etc., as a mask, the organic EL substrate is fabricated by a publicly known method by depositing the organic EL material (corresponding to the organic EL element 250a that emits red light in FIG. 1) emitting red light, an organic EL material (corresponding to the organic EL element 250b that emits green light in FIG. 1) emitting green light and an organic EL material (corresponding to the organic EL element 250c that emits blue light in FIG. 1) emitting blue light. The organic EL substrate is sealed with the sealing film, etc., (sealing substrate 2b in FIG. 1), and the device above the polyimide substrate is stripped from the glass substrate support by a publicly known stripping method such as laser stripping, etc., then to fabricate a Top-emission flexible organic EL display. When the polyimide of the present embodiment is used, a see-through flexible organic EL display can be fabricated. Further, a Bottom-emission flexible organic EL display may be fabricated by a publicly known method.

Examples of Manufacturing Flexible Liquid Crystal Display

A flexible liquid crystal display can be fabricated using the polyimide film of the present embodiment. As a specific fabricating method, a polyimide film is fabricated on a glass substrate support by the above method, and a TFT substrate consisting of, for example, amorphous silicon, a metal oxide semiconductor (IGZO, etc.), and low temperature polysilicon is fabricated by applying the above method. Separately, according to the coating and the film forming steps of the present embodiment, a polyimide film is fabricated on a glass substrate support, and a color filter glass substrate (CF substrate) provided with the polyimide film is fabricated using a color resist, etc., according to a publicly known method. To either the TFT substrate and the CF substrate, a surface of a frame-like pattern without the portion of the liquid crystal injection port is coated with a sealing material consisting of a thermosetting epoxy resin, etc., by screen printing, and to the other substrate, spherical spacers having a diameter equivalent to the thickness of the liquid crystal layer and consisting of a plastic material or silica, are scattered.

Then, the TFT substrate and the CF substrate are combined and attached together, and the sealing material is cured. Thereafter, a liquid crystal material is injected into the space surrounded by the TFT substrate, the CF substrate, as well as the sealing material by an evacuation method, the surface of the liquid crystal injection port is coated with a thermosetting resin, and the liquid crystal material is sealed with heating to form a liquid crystal layer. Finally, the flexible liquid crystal display can be fabricated by stripping the glass substrate on the CF side and the glass substrate on the TFT side, respectively at the interface between the polyimide film and the glass substrate by a laser stripping method, etc.

<Manufacturing Method of Laminate>

The method for manufacturing a laminate in the present embodiment comprises: a coating step of coating a surface of a support with the resin composition of the present embodiment; a film forming step of forming a polyimide resin film by heating the aforementioned resin composition, and an element forming step of forming an element on the aforementioned polyimide resin film.

As an element in the laminate, the elements illustrated in the manufacture of the aforementioned flexible device, are included. For example, a glass substrate can be used as a support. Preferred specific procedures of the coating step and the film forming step are the same as those in the manufacturing method of the polyimide film described above. Also, in the element forming step, the aforementioned element is formed on a polyimide resin film as a flexible substrate, formed on the support. Thereafter, the polyimide resin film and the element may be optionally stripped off from the support in the stripping step.

### EXAMPLES

Although the following provides a detailed explanation of the present invention in way of Examples thereof, these will be described for the purpose of explanation, and the scope of the present invention is not limited to the following Examples. Measurement, purification and evaluation in the Examples and Comparative Examples were carried out in accordance with the methods indicated below.

<<Measurement and Evaluation Method>>

### <Solid Content>

The total weight of the monomers used for the polyimide precursor can be used as the weight of the solid content contained in the resin composition. Alternatively, the solid content weight was determined by gas chromatography (hereinafter also referred to as GC) analysis of the resin composition, or by volatilization-removing of the solvent from the resin composition to determine the amount of the resulting volatile solvent, and determining the weight of the solid content by subtracting the weight of the solvent determined from the weight of the resin composition.

The conditions of GC include the following.

Apparatus: Gas chromatograph (gas chromatograph type 6890N manufactured by Agilent Technologies Japan, Ltd.)

Inlet temperature: 280° C.

Injection volume: 1 μL

Oven temperature: The temperature was held for 1 minute at 50° C. and then raised to 350° C. at the heating rate of 20° C./minute, and held for 5 minutes at 350° C.

Carrier gas: He, 1.0 ml/minute

Column: BPX5 (0.25 mmϕ×30 m, film thickness: 0.25 μm) manufactured by SGE Analytical Science Pty.

Split ratio: 50:1

Detector: Hydrogen flame ionization detector

Detector temperature: 355° C.

<Weight-Average Molecular Weight>

The weight-average molecular weight (Mw) and the number-average molecular weight (Mn) were measured by gel permeation chromatography (GPC) under the following conditions.

Column: Shodex KD-806M (manufactured by Showa Denko K.K.)

Flow rate: 1.0 mL/minute

Column temperature: 40° C.

Pump: PU-2080Plus (manufactured by JASCO Corporation)

Detector: RI-2031Plus (RI: differential refractometer, manufactured by JASCO Corporation) and UV-2075Plus (UV-VIS: ultraviolet-visible spectrophotometer, manufactured by JASCO Corporation).

As a solvent, NMP (for high performance liquid chromatograph manufactured by Wako Pure Chemical Industries Ltd., with 24.8 mmol/L of lithium bromide monohydrate (manufactured by Wako Pure Chemical Industries Ltd., purity: 99.5%) and 63.2 mmol/L of phosphoric acid (for high performance liquid chromatograph, manufactured by Wako Pure Chemical Industries, Ltd.), being added and dissolved to NMP just before measurement), was used. A calibration curve for calculating the weight-average molecular weight was prepared using standard polystyrenes (manufactured by Tosoh Corporation).

<Analysis of Concentration of Low Molecular Weight Cyclic Siloxane>

The concentration analysis of the low molecular weight cyclic siloxanes of formulas (7) and (8) contained in the resin composition and the solid content, was carried out by GC/MS (gas chromatography mass spectrometry) as described below (see below, analysis of concentration of low molecular weight cyclic siloxane (based on composition and solid content)).

The concentration analysis of the low molecular weight cyclic siloxanes of formulas (7) and (8) contained in the composition comprising the silicon-containing compounds (containing the compounds of formulas (3) and (4)) was carried out by GC (gas chromatography analysis) as described below (see below, analysis of concentration of low molecular weight cyclic siloxane (based on silicon-containing compound)).

<Analysis of Concentration of Low Molecular Weight Cyclic Siloxane (Based on Composition and Solid Content)>

### (1) Outline

First, a calibration line for quantifying the amount of cyclic siloxane was prepared. The calibration line was prepared according to the method described below using a standard (manufactured by Tokyo Chemical Industry Co., Ltd.) of n=4 cyclic siloxane (hereinafter also referred to as D4) of formula (8).

The amount of low molecular weight cyclic siloxane contained in the resin composition was measured by heating the resin composition at 150° C. and 200° C. for 30 minutes in a pyrolyzer and analyzing the volatile components generated by GC/MS. The peak area of each of the obtained compounds was converted to the D4 concentration using the calibration line preliminarily prepared.

GC/MS measurement was carried out using the following apparatus.

Pyrolyzer: Py-3030 iD (Frontier Lab)

GC system: 7890B (Agilent Technology)

MSD: 5977A (Agilent Technology)

Column: UA-1 (inner diameter: 0.25 mm, length: 15 m, liquid phase thickness: 0.25 μm)

### (Frontier Lab)

GC/MS measurements were carried out under the following measurement conditions for all the measurements.

Column temperature: The temperature was held at 40° C. for 5 minutes, then raised at the heating rate of 20° C./minute and held at 320° C. for 11 minutes (total duration time of 30 minutes).

Inlet temperature: 320° C.

Injection method: Split method (split ratio 1/20)

Interface temperature: 320° C.

Ion source temperature: 230° C.

Ionization method: Electron ionization method (EI)

Measurement method: SCAN method (m/z 10-800)

(2) Preparation of Calibration Line

The D4 standard (manufactured by Tokyo Chemical Industry Co., Ltd.) was weighed into a 10 mL-volumetric flask and chloroform was used as a solvent to prepare a sample with a concentration of 0.1 mg/mL of D4 and a sample of 0.01 mg/ml of D4.

A sampler suitable for sampling liquids was fitted to a pyrolyzer set at 400° C. and 1 μL of the aforementioned sample having the adjusted D4 concentration was weighted with a microsyringe and injected into the pyrolyzer. While heating the pyrolyzer at 400° C., the column was immersed in liquid nitrogen to trap volatile components in the column. After an elapse of one minute after heating was completed, the column was taken out from liquid nitrogen and subjected to GC/MS measurement. From the D4 concentrations and the peak areas obtained, the slope of the D4 calibration line was determined.

The retention time of each cyclic siloxane in GC/MS measurement using the aforementioned apparatus and measurement conditions are listed in Table 1 below. The same applies to the subsequent GC/MS measurements.

TABLE 1

| | Retention time |
|---|---|
| Compounds | (minute) |
| D3 | 3:08 |
| D4 | 7:35 |
| D5 | 9:12 |
| D6 | 10:30 |
| D7 | 11:37 |
| D8 | 12:30 |
| Dimethyl 3 diphenyl 1(D3ϕ) | 13:33 |
| Dimethyl 4 diphenyl 1(D4ϕ) | 14:14 |
| Dimethyl 5 diphenyl 1(D5ϕ) | 15:00 |

The Dn (n=3 to 8) in the above Table 1 each denotes the cyclic siloxane corresponding to n in the above formula (8). In addition, dimethyl m diphenyl 1 in Table 1 above, i.e., Dmϕ (m=3 to 5) is the cyclic siloxane corresponding to m in the above formula (7).

(3) Analysis of Concentration of Low Molecular Weight Cyclic Siloxanes of Formulas (7) and (8) in Resin Composition

As for the phenyl side chain of formula (7) contained in the resin composition, the resin composition was heated to 200° C. and GC/MS measurement of the volatilized components was carried out. On the other hand, for the methyl side chain of formula (8), the resin composition was heated to 150° C., and GC/MS measurement of the resulting volatile components was carried out. The concentration of each compound was calculated from the measurement results on the peak area of each volatile component in the resin composition. If the peak of each compound did not overlap with peaks of the other compounds, the peak area determined from the total ion chromatogram (TIC) was used. When the peak of each compound and the peaks of the other compounds overlap, the peak area obtained from the mass chromatogram (MS) of m/z=281 was used.

A. Analysis of Concentration of Low Molecular Weight Cyclic Siloxane of Formula (7) (Phenyl Side Chain) in Resin Composition

A sample cup containing the resin composition weighed at about 1 mg was placed in a heating furnace (He atmosphere) of a pyrolyzer set at 200° C. and heated at 200° C. for 30 minutes. The resulting volatile components were determined by GC/MS analysis. The peak area of each of the obtained compounds was converted to the D4 concentration using the calibration line preliminarily prepared. The amount of the low molecular weight cyclic siloxane of formula (7) was calculated according to the following formula:

Dmϕ(μg/g)={Dmϕ(GC-Area)}/{Slope of D4 calibration line}/{Weight (mg) of weighed resin composition}×1000

wherein the m corresponds to m in formula (7) and is an integer of 3 or more.

B. Analysis of Concentration of Low Molecular Weight Cyclic Siloxane of Formula (8) (Methyl Side Chain) in Resin Composition

A sample cup containing about 1 mg of the resin composition was placed in a heating furnace (He atmosphere) of a pyrolyzer set at 150° C. and heated at 150° C. for 30 minutes. The resulting volatile components were determined by GC/MS analysis. The peak area of each compound obtained was converted to the D4 concentration using the calibration line preliminarily prepared.

Dn (μg/g)={Dn (GC-Area)}/{Slope of D4 calibration line}/{Weight (mg) of weighed resin composition}×1000

wherein the n corresponds to n in formula (8) and is an integer of 3 or more.

(4) Analysis of Concentration of Low Molecular Weight Cyclic Siloxanes of Formulas (7) and (8) in Solid Content

The concentrations of the low molecular weight cyclic siloxanes of formulas (7) and (8) contained in the solid content were calculated from the aforementioned concentrations of the low molecular weight cyclic siloxanes of formulas (7) and (8) in the resin composition described above. Accordingly, the total weight of the monomers used for the polyimide precursor of each Example and Comparative Example is regarded as the weight of the solid content contained in the resin composition, and from the cyclic siloxane concentrations of formulas (7) and (8) in the resin composition and the total weight thereof, the cyclic siloxane concentrations of formulas (7) and (8) in solid content were calculated. The weight of the solid content contained in the resin composition can also be obtained, as described above, by measuring the solvent weight by GC analysis of the resin composition and subtracting the obtained solvent weight from the weight of the resin composition, or by heating the resin composition, removing the solvent by volatilization to determine the solvent weight, followed by subtracting the solvent weight from the weight of the resin composition.

<Analysis of Concentration of Low Molecular Weight Cyclic Siloxane Concentration (Based on Silicon-Containing Compound)>

### (Outline)

The concentration of the low molecular weight cyclic siloxane was measured by GC analysis of a solution of silicon-containing compounds (containing the compounds of formulas (3) and (4)) dissolved in acetone (containing n-tetradecane as an internal standard substance). From the peak area of each compound obtained, the concentration of each compound was determined based on the peak area of n-tetradecane according to the method described below.

GC measurement was carried out using the following apparatus.

GC system: 7890A (Agilent Technology)

Column: J & W Scientific Durabond DB-5MS (MEGABORE internal diameter: 0.53 mm, length: 30 m, liquid phase thickness: 1.0 μm)

GC measurements were carried out under the following measurement conditions for all the measurements.

Column temperature: 50° C., the temperature being raised at the heating rate of 10° C./minute and held at 280° C. for 17 minutes (total duration time of 40 minutes).

Inlet temperature: 270° C.

Carrier gas: He

Injection method: Split method (split ratio 1/10)

Detector: FID (300° C.)

### (Calculation of Amount of Low Molecular Weight Cyclic Siloxane)

The amount of the low molecular weight cyclic siloxane of formula (7) was calculated according to the following formula:

Dmϕ(μm/g)={Total weight (μg) of compound of formula (7)}/{Total weight (g) of compounds of formulas (3) and (4)}={Dmϕ(GC-Area)}/{N-tetradecane (GC-Area)×GC-Area Factor}×20×100

wherein the m corresponds to the number of carbon m of formula (7) and is an integer of 3 or greater.

The GC-Area Factor in the formula was calculated according to the following formula:

GC-Area Factor=molecular weight/number of carbon atom

The amount of the low molecular weight cyclic siloxane of formula (8) was calculated according to the following formula:

Dn (μg/g)={Total weight (μg) of compound of formula (8)}/{Total weight (g) of compounds of formulas (3) and (4)}={Dn (GC-Area)}/{N-tetradecane (GC-Area)×GC-Area Factor}×20×100

wherein the n corresponds to the number of carbon n of formula (8) and is an integer of 3 or greater.

The GC-Area Factor in the formula was calculated according to the following formula:

GC-Area Factor=molecular weight/number of carbon atom

The apparatus used and the retention time (minute) of each cyclic siloxane in GC measurement using the above measurement conditions are as shown in Table 2 below. The same applies to the subsequent GC measurement.

TABLE 2

| | Retention time |
|---|---|
| Compounds | (minute) |
| D3 | 3.8 |
| D4 | 6.1 |
| D5 | 8.4 |
| D6 | 10.7 |
| D7 | 12.8 |
| D8 | 14.6 |
| D3ϕ | 16.4 |
| D4ϕ | 17.4 |
| D5ϕ | 18.6 |
| Tetradecane | 12.2 |

The Dn (n=3 to 8) in the above Table 2 each denotes the cyclic siloxane corresponding to n in the above formula (8). Further, the Dmϕ (m=3 to 5) in the above Table 2 each denotes the cyclic siloxane corresponding to m in the above formula (7).

(Analysis of Concentration of Low Molecular Weight Cyclic Siloxane)

The concentration analysis of the low molecular weight cyclic siloxanes of formulas (7) and (8) contained in the silicon-containing compound was carried out by the following procedure. 0.1 g of the silicon-containing compound was dissolved in 10 mL of acetone (containing 20 μg/mL of n-tetradecane as an internal standard substance) and the mixture was allowed to stand for 16 hours. The solution allowed to stand was weighed at 1 μL with a microsyringe and injected to the GC apparatus for measurement. In the obtained chromatogram, the peak area of each low molecular weight cyclic siloxane and n-tetradecane were calculated using the software installed in the GC, and each concentration of the low molecular weight cyclic siloxanes was determined by the aforementioned calculation formula.

<<Purification Method of Silicon-Containing Compound>>

The silicon-containing compounds described in the Examples and Comparative Examples described below were subjected to the following purification A treatment to reduce the low molecular weight cyclic siloxane contained. The concentration of the low molecular weight cyclic siloxanes after purification was analyzed according to the above method.

### [Purification A]

10 kg of the silicon-containing compound was charged into a flask, and stripping was carried out while blowing nitrogen gas for 8 hours at a temperature of 160° C. and a pressure of 270 Pa.

### [Purification B]

Purification treatment based on the synthesis example of the both amino end-modified silicone oil (refined product) described in Japanese Unexamined Patent Application No. 2016-029126

In 100 g of the silicon-containing compound, 1000 g of acetone was added and stirred together at room temperature for 30 minutes. After centrifugation at 2500 rpm for 15 minutes using a centrifuge, acetone and silicone oil were separated followed by removal of acetone by decantation. After repeating this operation three times, acetone was distilled off with an evaporator to obtain the purified silicon-containing compound.

<Coating>

A surface of a glass substrate was coated (coating speed of 100 mm/second) with the polyimide precursor composition (varnish) to a 10 μm thickness film after imidization (in an oxygen concentration of 10 ppm by weight or less, being heated at 400° C. for 30 minutes following heating at 100° C. for 1 hour).

<Film Thickness Uniformity of Polyimide Precursor Coating Film after Heating and Vacuum Drying (HVCD)>

A surface of a 200 mm square alkali-free glass substrate (hereinafter, also referred to as glass substrate) was coated with the polyimide (PI) precursor composition to form a 10 μm thickness film after curing. A slit coater (TN25000, manufactured by Tokyo Ohka Kogyo Co., Ltd.) was used for the coating. Next, the solvent was removed by drying for 30 minutes under the conditions of 100 Pa and 100° C. in a heating vacuum drying (HVCD) dryer. The film thickness of the obtained PI precursor resin coating film was measured using a contact-step profiler at intervals of 50 mm. From the results thereof, the film thickness uniformity of the PI precursor coating film was evaluated and ranked (A to C) based on the following criteria.

A: In-plane uniformity (3 sigma) of less than 0.5.

B: In-plane uniformity (3 sigma) of 0.5 or more and less than 1.0

C: In-plane uniformity (3 sigma) of 1.0 or more

<Evaluation on Count of Foreign Substance on Polyimide Resin Film>

In this evaluation, in the case of drying and curing the polyimide precursors in large quantity using an oven to manufacture polyimide rein films in the same oven, the amount of foreign substances attached on the surfaces of the polyimide resin films was evaluated.

The surfaces of the 200 mm square alkali-free glass substrates (hereinafter also referred to as glass substrate) were coated with the resin compositions of Examples and Comparative Examples to form cured films each having a film thickness of 10 μm. A slit coater (TN25000, manufactured by Tokyo Ohka Kogyo Co., Ltd.) was used for the coating. In this case, one type of the resin composition was formed on 50 sheets of the glass substrates. One sheet of the glass substrate having the resin composition coating film was dried in an oven (KL0-30NH, manufactured by Koyo Thermo Systems Co., Ltd.) under a nitrogen atmosphere (oxygen concentration of 300 ppm or less) at 100° C. for 30 minutes to remove the solvent. Subsequently, the polyimide resin film was formed on the glass substrate by heating at 350° C. for 1 hour under a nitrogen atmosphere (oxygen concentration of 300 ppm or less). The size and number of the foreign substances were counted using a microscope (VHX-6000, manufactured by Keyence Corporation) in the center area of 50 mm square of the polyimide resin film obtained in the 200 mm square thereof. The observation conditions are as follows.

Lens: Magnification of 100 times

Threshold: Auto

Further, the number of foreign substances having a major axis of 50 μm or more and less than 1000 μm was evaluated and ranked (A to C) based on the following criteria.

The number of foreign substances is 10 or more and less than 50: Ranked as A (good) The number of foreign substances is 50 or more and less than 100: Ranked as B (fair) The number of foreign substances is 100 or more: Ranked as C (bad) The observed foreign substances were subjected to EDS analysis (elemental analysis) using a scanning electron microscope (JSM-IT500HR, manufactured by Nippon Denshi Co., Ltd.). As a result, C, Si, 0 element, etc., were observed and N element was not observed. From this result, the foreign substance is presumably such that the low molecular weight cyclic siloxane which was volatilized during vacuum drying adheres to the inner wall of the drying apparatus, and then falls, adheres again, etc.

It is noted that when the resin composition of a different type was evaluated, the evaluation was carried out after the oven had been subjected to baking treatment without samples at 600° C. for 5 hours or longer.

<Haze Evaluation>

In this evaluation, whether the haze value of the polyimide film was improved in the case of using a mixed solvent of the amide-based and non-amide-based solvents, compared to the case of using the single amide-based solvent, was evaluated.

A surface of a 200 mm square alkali-free glass substrate (hereinafter, also referred to as a glass substrate) was coated with the polyimide precursor composition to form a coating film with a film thickness of 10 μm after curing. A slit coater (TN25000, manufactured by Tokyo Ohka Kogyo Co., Ltd.) was used for the coating. Then, the solvent was removed by drying for 30 minutes at 100° C. in an IR (far-infrared) oven under a nitrogen atmosphere (oxygen concentration of 300 ppm or less). Subsequently, heating was carried out at 400° C. for 1 hour under a nitrogen atmosphere (oxygen concentration of 300 ppm or less) to form the polyimide resin film on the glass substrate.

The obtained sample was subjected to measurement of haze (converted for a film thickness of 10 μm) according to the transparency test method (JIS K7105) using a SC-3H haze meter manufactured by Suga Test Instruments Co., Ltd. The difference in haze values was determined based on the following equation using the haze values thereof:

Haze value difference=Haze value of PI film when using amide-based solvent−Haze value of PI film when using the aforementioned mixed solvent of amide-based and non-amide-based solvents.

A: The haze value difference of 0.6 or more (haze being ranked as “excellent”.) B: The haze value difference of 0.3 or more and less than 0.6 (haze being ranked as “good”)

C: The haze value difference of less than 0.3 (haze being ranked as “bad”)

### Example 1

NMP (181 g) and DGDE (181 g) were added to a 1 L separable flask with a stirring rod while introducing nitrogen gas, 4,4′-DAS (23.7 g) as diamine and silicon-containing compound 1 (10.56 g) (compound having the number-average molecular weight of 4400 wherein in formula (4), L₁ and L₂ are amino groups, R₁ is a methylene group, R₂, R₃, R₆ and R₇ are methyl groups, R₄ and R₅ are phenyl groups, and j/(i+j+k)=0.15) that was subjected to the aforementioned purification A treatment, were added with stirring, followed by addition of BPDA (29.4 g) as an acid dianhydride (molar ratio of the acid dianhydride and the diamine of 100:98). Next, the mixture was heated to 40° C. in an oil bath with stirring for 12 hours, then the oil bath was removed, and the mixture was returned to room temperature to obtain the transparent NMP solution of polyamic acid (hereinafter also referred to as varnish). The obtained varnish was stored in a freezer (temperature thereof was set to −20° C., and the same applies hereinafter.), and was defrosted when used for evaluation.

### Examples 2 to 38, Comparative Examples 1 to 18

The vanishes having the solid content weight of 15% by weight for all the vanishes were obtained and evaluated in the similar manner as in Example 1 with the exception of changing the diamine, silicon-containing compound, acid dianhydride, solvent, co-solvent, etc., according to Tables 3 to 6 below.

As for the silicon-containing compounds of Examples 2 to 38 and Comparative Examples 1 to 18, in Tables 3 to 6, those described as “untreated” were used without the aforementioned purification treatment, the silicon-containing compounds described as “purification A” were used after the aforementioned purification A treatment, and the silicon-containing compounds described as “purification B” were used after the aforementioned purification B treatment.

The results of the resin compositions and resin films obtained in the Examples and Comparative Examples are shown in Tables 3 to 10.

In Tables 3 to 6, the silicon-containing compounds 2 and 3 are as follows.

Silicone-containing compound 2: The compound having the number-average molecular weight of 3000, wherein in formula (4) L₁ and L₂ are amino groups, R₁ is a methylene group, R₂ and R₃ are methyl groups, and j and k are 0.

Silicone-containing compound 3: The compound having the number-average molecular weight of 4200, wherein in formula (4), L₁ and L₂ are acid anhydride groups, R₁ is a methylene group, R₂, R₃, R₆ and R₇ are methyl groups, R₄ and R₅ are phenyl groups, and j/(i+j+k)=0.15.

In Tables 7 to 10, “m=3 compound” corresponds to the compound having m=3 in formula (7) described above, and “formula (7) compound” corresponds to the compound in formula (7) wherein m is 3 to 5 described above, and “n=5 compound” corresponds to the compound having n=5 in formula (8) described above. In Comparative Example 4, the haze was not evaluated.

TABLE 3

| | | | | | | | | | Silicon- | |
|---|---|---|---|---|---|---|---|---|---|---|
| | Acid anhydride 1 | | Acid anhydride 2 | | Diamine 1 | | Diamine 2 | | containing compound | |
| | | Wt. | | Wt. | | Wt. | | Wt. | | Purification |
| | Type | (g) | Type | (g) | Type | (g) | Type | (g) | Type | treatment |
| Exam. 1 | BPDA | 29.4 | | | DAS | 23.7 | | | 1 | Purification A |
| Exam. 2 | BPDA | 29.4 | | | DAS | 23.7 | | | 1 | Purification A |
| Exam. 3 | BPDA | 29.4 | | | DAS | 23.7 | | | 1 | Purification A |
| Exam. 4 | BPDA | 29.4 | | | DAS | 23.7 | | | 1 | Purification A |
| Exam. 5 | BPDA | 29.4 | | | DAS | 23.7 | | | 1 | Purification A |
| Exam. 6 | BPDA | 29.4 | | | DAS | 23.7 | | | 1 | Purification A |
| Exam. 7 | BPDA | 29.4 | | | DAS | 23.7 | | | 1 | Purification A |
| Exam. 8 | BPDA | 29.4 | | | DAS | 23.7 | | | 1 | Purification A |
| Exam. 9 | BPDA | 29.4 | | | DAS | 23.7 | | | 1 | Purification A |
| Exam. 10 | BPDA | 29.4 | | | DAS | 23.7 | | | 1 | Purification A |
| Exam. 11 | BPDA | 29.4 | | | DAS | 23.7 | | | 1 | Purification A |
| Exam. 12 | BPDA | 29.4 | | | DAS | 23.7 | | | 1 | Purification A |

| | | | | | | Solvent ratio: |
|---|---|---|---|---|---|---|
| | Silicon- | | Amide- | | | amide-based |
| | containing compound | | based | Non-amide-based solvent | | solvent/non- |
| | Molecular | Wt. | solvent | | b.p. | amide-based |
| | weight | (g) | Type | Type | (° C.) | solvent |
| Exam. 1 | 4400 | 10.56 | NMP | DGDE | 188 | 50/50 |
| Exam. 2 | 4400 | 10.56 | NMP | GBL | 204 | 50/50 |
| Exam. 3 | 4400 | 10.56 | DMAc | GBL | 162 | 50/50 |
| Exam. 4 | 4400 | 10.56 | Equamide | GBL | 162 | 50/50 |
| | | | M100 | | | |
| Exam. 5 | 4400 | 10.56 | DMF | GBL | 162 | 50/50 |
| Exam. 6 | 4400 | 10.56 | TMU | GBL | 162 | 50/50 |
| Exam. 7 | 4400 | 10.56 | β-alkoxy- | GBL | 162 | 50/50 |
| | | | propionamide | | | |
| Exam. 8 | 4400 | 10.56 | NMP | Ethyl | 180 | 50/50 |
| | | | | acetoacetate | | |
| Exam. 9 | 4400 | 10.56 | NMP | DMI | 225 | 50/50 |
| Exam. 10 | 4400 | 10.56 | NMP | DMSO | 189 | 50/50 |
| Exam. 11 | 4400 | 10.56 | NMP | Sulfolane | 285 | 50/50 |
| Exam. 12 | 4400 | 10.56 | NMP | DIBK | 168 | 50/50 |
| | | | | (diisobutyl | | |
| | | | | ketone) | | |

TABLE 4

| | | | | | | | | | Silicon- | | | |
|---|---|---|---|---|---|---|---|---|---|---|---|---|
| | Acid anhydride 1 | | Acid anhydride 2 | | Diamine 1 | | Diamine 2 | | containing compound | | | |
| | | Wt. | | Wt. | | Wt. | | Wt. | | Purification | Molecular | Wt. |
| | Type | (g) | Type | (g) | Type | (g) | Type | (g) | Type | treatment | weight | (g) |
| Exam. 13 | BPDA | 29.4 | | | DAS | 23.7 | | | 1 | Purification A | 4400 | 10.56 |
| Exam. 14 | BPDA | 29.4 | | | DAS | 23.7 | | | 1 | Purification A | 4400 | 10.56 |
| Exam. 15 | BPDA | 29.4 | | | DAS | 23.7 | | | 1 | Purification A | 4400 | 10.56 |
| Exam. 16 | BPDA | 29.4 | | | DAS | 23.7 | | | 1 | Purification A | 4400 | 10.56 |
| Exam. 17 | BPDA | 29.4 | | | DAS | 23.7 | | | 1 | Purification A | 4400 | 10.56 |
| Exam. 18 | BPDA | 29.4 | | | DAS | 23.7 | | | 1 | Purification A | 4400 | 10.56 |
| Exam. 19 | BPDA | 29.4 | | | DAS | 23.7 | | | 1 | Purification A | 4400 | 10.56 |
| Exam. 20 | BPDA | 29.4 | | | DAS | 23.7 | | | 1 | Purification A | 4400 | 10.56 |
| Exam. 21 | BPDA | 29.4 | | | DAS | 23.7 | | | 1 | Purification A | 4400 | 10.56 |

| | | | | Solvent ratio: |
|---|---|---|---|---|
| | Amide- | | | amide-based |
| | based | Non-amide-based solvent | | solvent/non- |
| | solvent | | b.p. | amide-based |
| | Type | Type | (° C.) | solvent |
| Exam. 13 | NMP | MMBAc(CH₃)₂(OCH₃)C—(CH₂)₂OCOCH₃ | 188 | 50/50 |
| | | 3-Methoxy-3-methyl-butyl acetate | | |
| Exam. 14 | NMP | Butyl cellosolve C₄H₉O(CH₂)₂OH | 170 | 50/50 |
| Exam. 15 | NMP | Ethylene glycol | 197 | 50/50 |
| Exam. 16 | NMP | Butyl cellosolve acetate | 192 | 50/50 |
| | | Ethylene glycol mono-butyl ether acetate | | |
| Exam. 17 | NMP | Diethylene glycol | 245 | 50/50 |
| Exam. 18 | NMP | Diethylene glycol monoethyl ether | 202 | 50/50 |
| Exam. 19 | NMP | Diethylene glycol diethyl ether | 189 | 50/50 |
| Exam. 20 | NMP | Propylene glycol | 198 | 50/50 |
| Exam. 21 | NMP | Diethylene glycol dimethyl ether | 162 | 50/50 |

TABLE 5-1

| | | | | | | | | | Silicon- | |
|---|---|---|---|---|---|---|---|---|---|---|
| | Acidanhydride 1 | | Acidanhydride 2 | | Diamine 1 | | Diamine 2 | | containing compound | |
| | | Wt. | | Wt. | | Wt. | | Wt. | | Purification |
| | Type | (g) | Type | (g) | Type | (g) | Type | (g) | Type | treatment |
| Exam. 22 | BPDA | 29.4 | | | DAS | 11.9 | TFMB | 15.3 | 1 | Purification A |
| Exam. 23 | BPDA | 14.7 | PMDA | 10.9 | DAS | 11.9 | TFMB | 15.3 | 1 | Purification A |
| Exam. 24 | BPDA | 29.4 | | | Cyclohexane | 10.9 | | | 1 | Purification A |
| | | | | | diamine | | | | | |
| Exam. 25 | BPDA | 29.4 | | | Fluorene | 33.3 | | | 1 | Purification A |
| | | | | | diamine | | | | | |
| Exam. 26 | BPDA | 29.4 | | | Cyclohexane | 10.9 | | | 1 | Purification A |
| | | | | | diamine | | | | | |
| Exam. 27 | BPDA | 29.4 | | | WONDAMINE | 20.1 | | | 1 | Purification A |
| Exam. 28 | ODPA | 31.0 | | | DAS | 23.7 | | | 1 | Purification A |
| Exam. 29 | 6FDA | 44.4 | | | DAS | 23.7 | | | 1 | Purification A |
| Exam. 30 | HPMDA | 22.4 | | | DAS | 23.7 | | | 1 | Purification A |
| Exam. 31 | 9,9-Bis(4-(3,2- | 45.8 | | | DAS | 23.7 | | | 1 | Purification A |
| | dicarboxyphenoxy)- | | | | | | | | | |
| | phenyl) fluorene | | | | | | | | | |
| | dianhydride | | | | | | | | | |
| Exam. 32 | CpODA | 38.4 | | | DAS | 23.7 | | | 1 | Purification A |
| Exam. 33 | TAHQ | 45.8 | | | DAS | 23.7 | | | 1 | Purification A |
| Exam. 34 | BPDA | 29.4 | | | DAS | 23.7 | | | 1 | Purification A |
| Exam. 35 | BPDA | 29.4 | | | DAS | 23.7 | | | 1 | Purification A |
| Exam. 36 | BPDA | 29.4 | | | DAS | 23.7 | | | 1 | Purification A |
| Exam. 37 | BPDA | 29.4 | | | DAS | 23.7 | | | 2 | Purification A |
| Exam. 38 | BPDA | 8.6 | PMDA | 14.9 | DAS | 14.5 | TFMB | 12.4 | 3 | Purification A |

| | | | | | | Solvent ratio: |
|---|---|---|---|---|---|---|
| | Silicon- | | Amide- | | | amide-based |
| | containing compound | | based | Non-amide-based solvent | | solvent/non- |
| | Molecular | Wt. | solvent | | b.p. | amide-based |
| | weight | (g) | Type | Type | (° C.) | solvent |
| Exam. 22 | 4400 | 10.56 | NMP | DGDE | 188 | 50/50 |
| Exam. 23 | 4400 | 10.56 | NMP | DGDE | 188 | 50/50 |
| Exam. 24 | 4400 | 10.56 | Equamide | GBL | 162 | 50/50 |
| | | | M100 | | | |
| Exam. 25 | 4400 | 10.56 | NMP | GBL | 162 | 50/50 |
| Exam. 26 | 4400 | 10.56 | NMP | GBL | 162 | 50/50 |
| Exam. 27 | 4400 | 10.56 | NMP | GBL | 162 | 50/50 |
| Exam. 28 | 4400 | 10.56 | NMP | GBL | 162 | 50/50 |
| Exam. 29 | 4400 | 10.56 | NMP | GBL | 162 | 50/50 |
| Exam. 30 | 4400 | 10.56 | NMP | GBL | 162 | 50/50 |
| Exam. 31 | 4400 | 10.56 | NMP | GBL | 162 | 50/50 |
| Exam. 32 | 4400 | 10.56 | NMP | GBL | 162 | 50/50 |
| Exam. 33 | 4400 | 10.56 | NMP | GBL | 162 | 50/50 |
| Exam. 34 | 4400 | 10.56 | NMP | DGDE | 188 | 50/50 |
| Exam. 35 | 4400 | 10.56 | NMP | GBL | 204 | 50/50 |
| Exam. 36 | 4400 | 10.56 | DMAc | GBL | 162 | 50/50 |
| Exam. 37 | 2200 | 6.60 | NMP | DGDE | 188 | 50/50 |
| Exam. 38 | 2100 | 10.10 | NMP | DGDE | 188 | 50/50 |

TABLE 6

| | | | | | | | | | Silicon- | |
|---|---|---|---|---|---|---|---|---|---|---|
| | Acid anhydride 1 | | Acid anhydride 2 | | Diamine 1 | | Diamine 2 | | containing compound | |
| | | Wt. | | Wt. | | Wt. | | Wt. | | Purification |
| | Type | (g) | Type | (g) | Type | (g) | Type | (g) | Type | treatment |
| Comp. Exam. 1 | BPDA | 29.4 | | | DAS | 23.7 | | | 1 | Non-treatment |
| Comp. Exam. 2 | BPDA | 29.4 | | | DAS | 23.7 | | | 1 | Non-treatment |
| Comp. Exam. 3 | BPDA | 29.4 | | | DAS | 23.7 | | | 1 | Non-treatment |
| Comp. Exam. 4 | BPDA | 29.4 | | | DAS | 23.7 | | | 1 | Non-treatment |
| Comp. Exam. 5 | BPDA | 29.4 | | | DAS | 23.7 | | | 1 | Non-treatment |
| Comp. Exam. 6 | BPDA | 29.4 | | | DAS | 23.7 | | | 1 | Non-treatment |
| Comp. Exam. 7 | BPDA | 29.4 | | | DAS | 23.7 | | | 1 | Non-treatment |
| Comp. Exam. 8 | BPDA | 29.4 | | | DAS | 23.7 | | | 1 | Non-treatment |
| Comp. Exam. 9 | BPDA | 29.4 | | | DAS | 23.7 | | | 1 | Non-treatment |
| Comp. Exam. 10 | BPDA | 29.4 | | | DAS | 23.7 | | | 1 | Non-treatment |
| Comp. Exam. 11 | BPDA | 29.4 | | | DAS | 23.7 | | | 1 | Non-treatment |
| Comp. Exam. 12 | BPDA | 29.4 | | | DAS | 23.7 | | | 1 | Non-treatment |
| Comp. Exam. 13 | BPDA | 29.4 | | | DAS | 23.7 | | | 1 | Non-treatment |
| Comp. Exam. 14 | BPDA | 29.4 | | | DAS | 23.7 | | | 1 | Non-treatment |
| Comp. Exam. 15 | BPDA | 29.4 | | | DAS | 23.7 | | | 1 | Purification B |
| Comp. Exam. 16 | BPDA | 29.4 | | | DAS | 23.7 | | | 1 | Purification B |
| Comp. Exam. 17 | BPDA | 29.4 | | | DAS | 23.7 | | | 1 | Purification B |
| Comp. Exam. 18 | BPDA | 29.4 | | | DAS | 23.7 | | | 1 | Purification B |

| | | | | | | Solvent ratio: |
|---|---|---|---|---|---|---|
| | Silicon- | | Amide- | | | amide-based |
| | containing compound | | based | Non-amide based solvent | | solvent/non- |
| | Molecular | Wt. | solvent | | b.p. | amide-based |
| | weight | (g) | Type | Type | (° C.) | solvent |
| Comp. Exam. 1 | 4400 | 10.56 | NMP | Cyclopentanone | 155 | 50/50 |
| Comp. Exam. 2 | 4400 | 10.56 | DMAc | Cyclopentanone | 155 | 50/50 |
| Comp. Exam. 3 | 4400 | 10.56 | Equamide M100 | Cyclopentanone | 155 | 50/50 |
| Comp. Exam. 4 | 4400 | 10.56 | NMP | | | 50/50 |
| Comp. Exam. 5 | 4400 | 10.56 | NMP | THF | 66 | 50/50 |
| Comp. Exam. 6 | 4400 | 10.56 | NMP | Acetonitrile | 82 | 50/50 |
| Comp. Exam. 7 | 4400 | 10.56 | NMP | PGME | 120 | 50/50 |
| Comp. Exam. 8 | 4400 | 10.56 | NMP | PGMEA | 146 | 50/50 |
| Comp. Exam. 9 | 4400 | 10.56 | NMP | Ethyl lactate | 154 | 50/50 |
| Comp. Exam. 10 | 4400 | 10.56 | NMP | Cyclopentanone | 155 | 50/50 |
| Comp. Exam. 11 | 4400 | 10.56 | NMP | DGDE | 188 | 50/50 |
| Comp. Exam. 12 | 4400 | 10.56 | NMP | GBL | 204 | 50/50 |
| Comp. Exam. 13 | 4400 | 10.56 | DMAc | GBL | 162 | 50/50 |
| Comp. Exam. 14 | 4400 | 10.56 | Equamide M100 | GBL | 162 | 50/50 |
| Comp. Exam. 15 | 4400 | 10.56 | NMP | DGDE | 188 | 50/50 |
| Comp. Exam. 16 | 4400 | 10.56 | NMP | GBL | 204 | 50/50 |
| Comp. Exam. 17 | 4400 | 10.56 | DMAc | GBL | 162 | 50/50 |
| Comp. Exam. 18 | 4400 | 10.56 | Equamide M100 | GBL | 162 | 50/50 |

TABLE 7

| | | Cyclic siloxane concentration [ppm] | | | Cyclic siloxane concentration [ppm] | | |
|---|---|---|---|---|---|---|---|
| | Weight-average | (resin composition basis) | | | (solid content basis) | | |
| | molecular weight | m = 3 | Formula (7) | n = 5 | m = 3 | Formula (7) | n = 5 |
| | of PI precursor | compound | compound | compound | compound | compound | compound |
| Exam. 1 | 105,000 | 439 | 802 | 32 | 2930 | 5345 | 259 |
| Exam. 2 | 104,000 | 546 | 1017 | 21 | 3637 | 6778 | 208 |
| Exam. 3 | 105,000 | 448 | 818 | 23 | 2989 | 5453 | 153 |
| Exam. 4 | 105,000 | 691 | 1192 | 20 | 4923 | 7442 | 135 |
| Exam. 5 | 105,000 | 448 | 818 | 23 | 2989 | 5453 | 153 |
| Exam. 6 | 105,000 | 439 | 802 | 21 | 2930 | 5345 | 208 |
| Exam. 7 | 105,000 | 546 | 1017 | 23 | 3637 | 6778 | 153 |
| Exam. 8 | 105,000 | 691 | 1192 | 32 | 4923 | 7442 | 259 |
| Exam. 9 | 105,000 | 448 | 818 | 23 | 2989 | 5453 | 153 |
| Exam. 10 | 105,000 | 439 | 802 | 21 | 2930 | 5345 | 208 |
| Exam. 11 | 105,000 | 546 | 1017 | 23 | 3637 | 6778 | 153 |
| Exam. 12 | 105,000 | 691 | 1192 | 32 | 4923 | 7442 | 259 |

| | | | | Film thickness | | |
|---|---|---|---|---|---|---|
| | Cyclic siloxane concentration [ppm] | | | uniformity of | Evaluation | |
| | (silicon-containing compound basis) | | | PI precursor | of count of | |
| | m = 3 | Formula (7) | n = 5 | coating film | foreign | |
| | compound | Compound | compound | after HVCD | substance | Haze |
| Exam. 1 | 18356 | 33128 | 921 | A | A | A |
| Exam. 2 | 24886 | 45876 | 943 | A | A | A |
| Exam. 3 | 18356 | 33128 | 959 | A | A | A |
| Exam. 4 | 24886 | 45876 | 914 | A | A | A |
| Exam. 5 | 18356 | 33128 | 959 | A | A | A |
| Exam. 6 | 18356 | 33128 | 943 | A | A | A |
| Exam. 7 | 24886 | 45876 | 959 | A | A | A |
| Exam. 8 | 24886 | 45876 | 921 | A | A | A |
| Exam. 9 | 18356 | 33128 | 959 | A | A | A |
| Exam. 10 | 18356 | 33128 | 943 | A | A | A |
| Exam. 11 | 24886 | 45876 | 959 | A | A | A |
| Exam. 12 | 24886 | 45876 | 921 | A | A | A |

TABLE 8

| | | Cyclic siloxane concentration [ppm] | | | Cyclic siloxane concentration [ppm] | | |
|---|---|---|---|---|---|---|---|
| | Weight-average | (resin composition basis) | | | (solid content basis) | | |
| | molecular weight | m = 3 | Formula (7) | n = 5 | m = 3 | Formula (7) | n = 5 |
| | of PI precursor | compound | compound | compound | compound | compound | compound |
| Exam. 13 | 105,000 | 448 | 818 | 23 | 2989 | 5453 | 153 |
| Exam. 14 | 105,000 | 691 | 1192 | 20 | 4923 | 7442 | 135 |
| Exam. 15 | 105,000 | 448 | 818 | 23 | 2989 | 5453 | 153 |
| Exam. 16 | 105,000 | 439 | 802 | 21 | 2930 | 5345 | 208 |
| Exam. 17 | 105,000 | 546 | 1017 | 23 | 3637 | 6778 | 153 |
| Exam. 18 | 105,000 | 448 | 818 | 20 | 2989 | 5453 | 135 |
| Exam. 19 | 105,000 | 691 | 1192 | 32 | 4923 | 7442 | 259 |
| Exam. 20 | 105,000 | 439 | 802 | 21 | 2930 | 5345 | 208 |
| Exam. 21 | 105,000 | 546 | 1017 | 23 | 3637 | 6778 | 153 |

| | | | | Film thickness | | |
|---|---|---|---|---|---|---|
| | Cyclic siloxane concentration [ppm] | | | uniformity of | Evaluation | |
| | (silicon-containing compound basis) | | | PI precursor | of count of | |
| | m = 3 | Formula (7) | n = 5 | coating film | foreign | |
| | compound | compound | compound | after HVCD | substance | Haze |
| Exam. 13 | 18356 | 33128 | 959 | A | A | A |
| Exam. 14 | 24886 | 45876 | 914 | A | A | A |
| Exam. 15 | 18356 | 33128 | 959 | A | A | A |
| Exam. 16 | 18356 | 33128 | 943 | A | A | A |
| Exam. 17 | 24886 | 45876 | 959 | A | A | A |
| Exam. 18 | 18356 | 33128 | 769 | A | A | A |
| Exam. 19 | 24886 | 45876 | 921 | A | A | A |
| Exam. 20 | 18356 | 33128 | 943 | A | A | A |
| Exam. 21 | 24886 | 45876 | 959 | A | A | A |

TABLE 9

| | | Cyclic siloxane concentration [ppm] | | | | | |
|---|---|---|---|---|---|---|---|
| | | (resin composition basis) | | | Cyclic siloxane concentration [ppm] | | |
| | Weight-average | m = 3 | | | (solid content basis) | | |
| | molecular weight | compound | Formula (7) | n = 5 | m = 3 | Formula (7) | n = 5 |
| | of PI precursor | compound | compound | compound | compound | compound | compound |
| Exam. 22 | 109,000 | 546 | 1017 | 15 | 3637 | 6778 | 100 |
| Exam. 23 | 109,000 | 448 | 818 | 20 | 2989 | 5453 | 135 |
| Exam. 24 | 105,000 | 691 | 1192 | 32 | 4923 | 7442 | 259 |
| Exam. 25 | 148,000 | 546 | 1017 | 23 | 3637 | 6778 | 153 |
| Exam. 26 | 125,000 | 448 | 818 | 20 | 2989 | 5453 | 135 |
| Exam. 27 | 130,000 | 439 | 802 | 15 | 2930 | 5345 | 100 |
| Exam. 28 | 92,000 | 546 | 1017 | 15 | 3637 | 6778 | 100 |
| Exam. 29 | 130,000 | 448 | 818 | 20 | 2989 | 5453 | 135 |
| Exam. 30 | 72,000 | 691 | 1192 | 32 | 4923 | 7442 | 259 |
| Exam. 31 | 114,000 | 546 | 1017 | 23 | 3637 | 6778 | 153 |
| Exam. 32 | 67,000 | 448 | 818 | 20 | 2989 | 5453 | 135 |
| Exam. 33 | 124,000 | 439 | 802 | 15 | 2930 | 5345 | 100 |
| Exam. 34 | 105,000 | 439 | 802 | 21 | 2930 | 5345 | 208 |
| Exam. 35 | 104,000 | 546 | 1017 | 23 | 3637 | 6778 | 153 |
| Exam. 36 | 105,000 | 448 | 818 | 20 | 2989 | 5453 | 135 |
| Exam. 37 | 105,000 | — | — | 7 | — | — | 44 |
| Exam. 38 | 105,000 | 448 | 818 | 20 | 2989 | 5453 | 135 |

| | | | | Film thickness | | |
|---|---|---|---|---|---|---|
| | Cyclic siloxane concentration [ppm] | | | uniformity of | Evaluation | |
| | (silicon-containing compound basis) | | | PI precursor | of count of | |
| | m = 3 | Formula (7) | n = 5 | coating film | foreign | |
| | compound | Compound | compound | after HVCD | substance | Haze |
| Exam. 22 | 24886 | 45876 | 801 | A | A | A |
| Exam. 23 | 18356 | 33128 | 769 | A | A | A |
| Exam. 24 | 24886 | 45876 | 921 | A | A | A |
| Exam. 25 | 24886 | 45876 | 959 | A | A | A |
| Exam. 26 | 18356 | 33128 | 914 | A | A | A |
| Exam. 27 | 18356 | 33128 | 801 | A | A | A |
| Exam. 28 | 24886 | 45876 | 801 | A | A | A |
| Exam. 29 | 18356 | 33128 | 769 | A | A | A |
| Exam. 30 | 24886 | 45876 | 921 | A | A | A |
| Exam. 31 | 24886 | 45876 | 959 | A | A | A |
| Exam. 32 | 18356 | 33128 | 914 | A | A | A |
| Exam. 33 | 18356 | 33128 | 801 | A | A | A |
| Exam. 34 | 18356 | 33128 | 943 | A | A | A |
| Exam. 35 | 24886 | 45876 | 959 | A | A | A |
| Exam. 36 | 18356 | 33128 | 914 | A | A | A |
| Exam. 37 | — | — | 295 | A | A | A |
| Exam. 38 | 18356 | 33128 | 769 | A | A | A |

TABLE 10

| | | Cyclic siloxane concentration [ppm] | | | Cyclic siloxane concentration [ppm] | | |
|---|---|---|---|---|---|---|---|
| | Weight-average | (resin composition basis) | | | (solid content basis) | | |
| | molecular weight | m = 3 | Formula (7) | n = 5 | m = 3 | Formula (7) | n = 5 |
| | of PI precursor | compound | compound | compound | compound | compound | compound |
| Comp. Exam. 1 | 101,000 | 779 | 1364 | 58 | 5196 | 9094 | 387 |
| Comp. Exam. 2 | 105,000 | 826 | 1374 | 65 | 5509 | 9160 | 431 |
| Comp. Exam. 3 | 105,000 | 812 | 1433 | 63 | 5412 | 9555 | 418 |
| Comp. Exam. 4 | 101,000 | 792 | 1319 | 65 | 5279 | 8794 | 431 |
| Comp. Exam. 5 | 102,000 | 768 | 1274 | 63 | 5120 | 8495 | 418 |
| Comp. Exam. 6 | 102,000 | 792 | 1319 | 65 | 5279 | 8794 | 431 |
| Comp. Exam. 7 | 100,000 | 838 | 1353 | 60 | 5587 | 9019 | 398 |
| Comp. Exam. 8 | 101,000 | 826 | 1374 | 65 | 5509 | 9160 | 431 |
| Comp. Exam. 9 | 100,000 | 812 | 1433 | 63 | 5412 | 9555 | 418 |
| Comp. Exam. 10 | 101,000 | 792 | 1319 | 65 | 5279 | 8794 | 431 |
| Comp. Exam. 11 | 105,000 | 866 | 1535 | 65 | 5775 | 10235 | 431 |
| Comp. Exam. 12 | 104,000 | 779 | 1364 | 60 | 5196 | 9094 | 398 |
| Comp. Exam. 13 | 105,000 | 826 | 1374 | 58 | 5509 | 9160 | 387 |
| Comp. Exam. 14 | 105,000 | 812 | 1433 | 65 | 5412 | 9555 | 431 |
| Comp. Exam. 15 | 105,000 | 768 | 1274 | 63 | 5120 | 8495 | 418 |
| Comp. Exam. 16 | 104,000 | 792 | 1319 | 65 | 5279 | 8794 | 431 |
| Comp. Exam. 17 | 105,000 | 838 | 1353 | 60 | 5587 | 9019 | 398 |
| Comp. Exam. 18 | 105,000 | 792 | 1319 | 65 | 5279 | 8794 | 431 |

| | | | | Film thickness | | |
|---|---|---|---|---|---|---|
| | Cyclic siloxane concentration [ppm] | | | uniformity of | Evaluation | |
| | (silicon-containing compound basis) | | | PI precursor | of count of | |
| | m = 3 | Formula (7) | n = 5 | coating film | foreign | |
| | compound | Compound | compound | after HVCD | substance | Haze |
| Comp. Exam. 1 | 31524 | 52416 | 2345 | C | C | C |
| Comp. Exam. 2 | 31524 | 52416 | 2466 | C | C | C |
| Comp. Exam. 3 | 31524 | 52416 | 2432 | C | C | C |
| Comp. Exam. 4 | 28981 | 49211 | 2354 | C | C | — |
| Comp. Exam. 5 | 26829 | 48913 | 2432 | C | C | C |
| Comp. Exam. 6 | 28981 | 49211 | 2354 | C | C | C |
| Comp. Exam. 7 | 29276 | 50962 | 2267 | C | C | C |
| Comp. Exam. 8 | 31524 | 52416 | 2466 | C | C | C |
| Comp. Exam. 9 | 31524 | 52416 | 2432 | C | C | C |
| Comp. Exam. 10 | 28981 | 49211 | 2354 | C | C | C |
| Comp. Exam. 11 | 31524 | 52416 | 2354 | B | C | A |
| Comp. Exam. 12 | 31524 | 52416 | 2267 | B | C | A |
| Comp. Exam. 13 | 31524 | 52416 | 2345 | B | C | A |
| Comp. Exam. 14 | 31524 | 52416 | 2466 | B | C | A |
| Comp. Exam. 15 | 26829 | 48913 | 2432 | B | C | A |
| Comp. Exam. 16 | 28981 | 49211 | 2354 | B | C | A |
| Comp. Exam. 17 | 29276 | 50962 | 2267 | B | C | A |
| Comp. Exam. 18 | 28981 | 49211 | 2466 | B | C | A |

### EXPLANATION OF SYMBOLS

2a Lower substrate
2b Sealing substrate
25 Portion of organic EL structure
250a Organic EL element emitting red light
250b Organic EL element emitting green light
250c Organic EL element emitting blue light
251 Partition wall (bank)
252 Lower electrode (anode)
253 Hole transport layer
254 Light emitting layer
255 Upper electrode (cathode)
256 TFT
257 Contact hole
258 Interlayer dielectric film
259 Lower electrode
261 Hallow portion

1. A resin composition comprising:
a polyimide precursor containing:
a structure unit represented by formula (1): 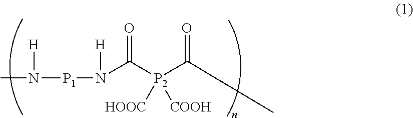
wherein P₁ represents a divalent organic group, P₂ represents a tetravalent organic group, and p is a positive integer, and
a structure unit represented by formula (2): 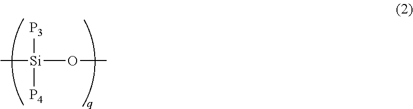
wherein P₃ and P₄ are each independently a monovalent aliphatic hydrocarbon group of 1 to 5 carbon atoms or a monovalent aromatic group of 6 to 10 carbon atoms, and q is a positive integer; and
a solvent;
wherein the solvent is a mixture of an amide-based solvent and a non-amide-based solvent having a boiling point of 160° C. or higher, and
the resin composition satisfies at least one of following (I) to (III):
(I) the resin composition comprises a compound represented by formula (3): 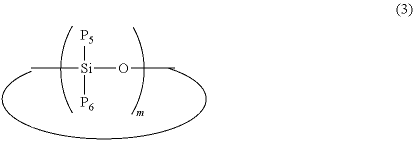
wherein P₅ and P₆ are each independently a monovalent aliphatic hydrocarbon group of 1 to 5 carbon atoms or an aromatic group of 6 to 10 carbon atoms, and m is a positive integer, in an amount of greater than 0 ppm to 1200 ppm or less based on a weight of the resin composition;
(II) the resin composition comprises the compound represented by formula (3) provided that P₅ and P₆ are each independently an aromatic group of 6 to 10 carbon atoms and m is 3, in an amount of greater than 0 ppm to 700 ppm or less based on a weight of the resin composition; and
(III) the resin composition comprises the compound represented by formula (3) provided that P₅ and P₆ are each independently a monovalent aliphatic hydrocarbon group of 1 to 5 carbon atoms and m is 5, in an amount of greater than 0 ppm to 35 ppm or less based on a weight of the resin composition.

2. The resin composition according to claim 1, wherein P₅ and P₆ are each independently an aromatic group of 6 to 10 carbon atoms, and m is a positive integer in formula (3).

3. The resin composition according to claim 1, wherein m is 3 or greater in formula (3).

4-5. (canceled)

6. A resin composition comprising:
a polyimide precursor containing:
a structure unit represented by formula (1): 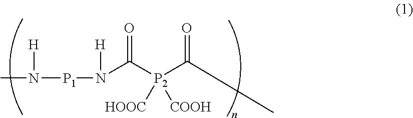
wherein P₁ represents a divalent organic group, P₂ represents a tetravalent organic group, and p is a positive integer, and
a structure unit represented by formula (2): 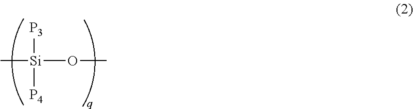
wherein P₃ and P₄ are each independently a monovalent aliphatic hydrocarbon group of 1 to 5 carbon atoms or a monovalent aromatic group of 6 to 10 carbon atoms, and q is a positive integer; and
a solvent;
wherein the solvent is a mixture of an amide-based solvent and a non-amide-based solvent having a boiling point of 160° C. or higher, and
the resin composition comprises a compound represented by formula (3): 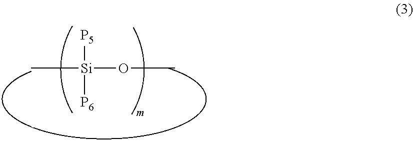
wherein P₅ and P₆ are each independently a monovalent aliphatic hydrocarbon group of 1 to 5 carbon atoms or an aromatic group of 6 to 10 carbon atoms, and m is a positive integer, and
the resin composition comprises the compound represented by formula (3) provided that P₅ and P₆ are each independently an aromatic group of 6 to 10 carbon atoms and m is 3, in an amount of greater than 0 ppm to 5000 ppm or less based on a solid content weight of the resin composition, and/or the compound represented by formula (3) provided that P₅ and P₆ are each independently a monovalent aliphatic hydrocarbon group of 1 to 5 carbon atoms and m is 5, in an amount of greater than 0 ppm to 300 ppm or less based on a solid content weight of the resin composition.

7-9. (canceled)

10. A method of preparing a resin composition, comprising:
providing a polyimide precursor by subjecting a silicon-containing compound containing:
a compound represented by formula (4): 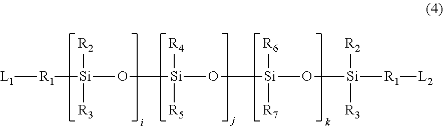
wherein R₁ is each independently, single bond or a divalent organic group of 1 to 10 carbon atoms, R₂ and R₃ are each independently a monovalent aliphatic hydrocarbon group of 1 to 5 carbon atoms, R₄ and R₅ are each independently a monovalent aromatic group of 6 to 10 carbon atoms, R₆ and R₇ are each independently a monovalent organic group of 1 to 10 carbon atoms, at least one of R₆ and R₇ is an organic group having an unsaturated aliphatic hydrocarbon group, L₁ and L₂ are each independently an amino group, an acid anhydride group, an isocyanate group, a carboxy group, an acid ester group, an acid halide group, a hydroxy group, an epoxy group or a mercapto group, i is an integer of 1 to 200, and j and k are each independently an integer of 0 to 200, and
a compound represented by formula (3): 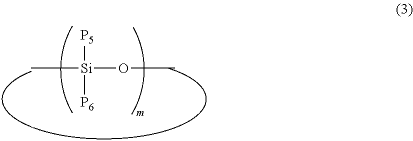
wherein P₅ and P₆ are each independently a monovalent aliphatic hydrocarbon group of 1 to 5 carbon atoms or an aromatic group of 6 to 10 carbon atoms, and m is a positive integer;
tetracarboxylic acid dianhydride; and
diamine;
to polycondensation reaction,
wherein a total amount of the compound represented by formula (3) provided that P₅ and P₆ are each independently an aromatic group of 6 to 10 carbon atoms and m is 3, is greater than 0 ppm to 25000 ppm or less based on weights of the compound represented by formula (3) and the silicon-containing compound represented by formula (4), and/or
wherein a total amount of the compound represented by formula (3) provided that P₅ and P₆ are each independently a monovalent aliphatic hydrocarbon group of 1 to 5 carbon atoms and m is 5, is greater than 0 ppm to 1500 ppm or less based on weights of the compound represented by formula (3) and the silicon-containing compound represented by formula (4).

11. (canceled)

12. The resin composition according to claim 1, wherein the amide-based solvent is at least one selected from the group consisting of N,N-dimethylformamide (DMF), N,N-dimethylacetamide (DMAc), N-methyl-2-pyrrolidone (NMP), N-methylcaprolactam, tetramethylurea (TMU), β-alkoxypropionamide, and an amide compound represented by formula (5): 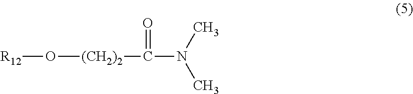
wherein R₁₂ is an alkyl group.

13. The resin composition according to claim 1, wherein the non-amide-based solvent having a boiling point of 160° C. or higher is at least one selected from the group consisting of γ-butyrolactone (GBL), ethyl acetoacetate, 1,3-dimethyl-2-imidazolidinone, dimethyl sulfoxide, sulfolane, diisobutyl ketone, 3-methoxy-3-methyl butyl acetate, butyl cellosolve, butyl cellosolve acetate, ethylene glycol, diethylene glycol, diethylene glycol monoethyl ether, diethylene glycol dimethyl ether, diethylene glycol diethyl ether (DMDG), propylene glycol, dipropylene glycol dimethyl ether, and dipropylene glycol methyl ether acetate.

14. The resin composition according to claim 10, wherein the tetracarboxylic acid dianhydride is at least one selected from the group consisting of pyromellitic acid dianhydride, 3,3′,4,4′-biphenyltetracarboxylic acid dianhydride, 4,4′-oxydiphthalic acid anhydride, cyclohexanetetracarboxylic acid dianhydride, cyclobutanetetracarboxylic acid dianhydride, 4,4′-(hexafluoroisopropylidene)diphthalic anhydride, 9,9-bis[4-(3,1-, 3,2-, 3,3- or 3,4-dicarboxyphenoxy)phenyl]fluorene dianhydride, norbornane-2-spiro-α-cyclopentanone-α′-spiro-2″-norbornane-5,5″,6,6″-tetracarboxylic acid dianhydride (CpODA), P-phenylene bis(trimellitate anhydride) (TAHQ), and 3,3′,4,4′-diphenyl sulfone tetracarboxylic acid dianhydride (DSDA).

15. The resin composition according to claim 10, wherein the diamine is at least one selected from the group consisting of 4,4′-diamino diphenyl sulfone, m-tolidine, p-phenylene diamine, 2,2′-bis(trifluoromethyl)benzidine, 2,2′-bis[4-(4-aminophenoxy)phenyl]propane, cyclohexanediamine, and 4,4′-diaminodicyclohexylmethane.

16. The resin composition according to claim 10, wherein the resin composition is subjected to vacuum distillation to reduce the compound represented by formula (3) which is contained in the silicon-containing compound represented by formula (4).

17. The resin composition according to claim 10, wherein the resin composition is allowed to stand for 2 to 12 hours under conditions of 200° C. to 300° C. and 300 Pa or lower in reducing the compound represented by formula (3) which is contained in the silicon-containing compound represented by formula (4).

18. The resin composition according to claim 1, wherein the resin composition is allowed to stand under a condition of vacuum of 100 Pa or lower to remove the solvent from the resin composition or to cure the resin composition to obtain polyimide.

19. The resin composition according to claim 1, wherein the resin composition is heated by far-infrared rays in curing the resin composition to obtain polyimide.

20. (canceled)

21. The resin composition according to claim 1, wherein a polyimide resin film obtained by curing the polyimide precursor is used for a flexible substrate.

22. The resin composition according to claim 1, wherein a polyimide resin film obtained by curing the polyimide precursor is used for a flexible display.

23. A method of preparing a polyimide film, comprising:
coating a surface of a support with the resin composition according to claim 1,
forming a polyimide resin film by heating the resin composition, and
stripping the polyimide resin film from the support.

24. The method according to claim 23, further comprising irradiating a laser to the resin composition from the support side, prior to the stripping the polyimide resin film from the support.

25. A method of preparing a display, comprising:
coating a surface of a support with the resin composition according to claim 1,
forming a polyimide resin film by heating the resin composition,
forming an element on the polyimide resin film, and
stripping the polyimide resin film on which the element was formed from the support.

26. A method of preparing a laminate, comprising:
coating a surface of a support with the resin composition according to claim 1,
forming a polyimide resin film by heating the resin composition, and
forming an element on the polyimide resin film.

27. The method according to claim 26, which further comprises stripping the polyimide resin film on which the element is formed, from the support.

28. A method of preparing a flexible device, comprising the method according to claim 26.

29. A polyimide film, which is a cured product of the resin composition according to claim 1.
